(19) United States
(12) Patent Application Publication
(10) Pub. No.: US 2019/0147507 A1
(43) Pub. Date: May 16, 2019

(54) Method and Apparatus for Collecting Survey Data

(71) Applicants: Debra Lukacsko, Plano, TX (US); Sagar Kogekar, Maharashtra (IN); Frederick Lightbourn, Nassau (BS)

(72) Inventors: Debra Lukacsko, Plano, TX (US); Sagar Kogekar, Maharashtra (IN); Frederick Lightbourn, Nassau (BS)

(21) Appl. No.: 15/582,735

(22) Filed: Apr. 30, 2017

Related U.S. Application Data
(60) Provisional application No. 62/341,015, filed on May 24, 2016.

(51) Int. Cl. G06Q 30/02

(52) U.S. Cl. CPC G06Q 30/0282; G06Q 30/0281; G06Q 30/0205; G06Q 30/0203

(57) ABSTRACT

A survey system and method for customer ratings of services using a survey server having at least one access point, A geo-fenced-restricted communication protocol is used to restrict rating activity to a location. A wireless communication link is used to configure a mobile communication display device, such as a customer's smart phone, tablet, PDA or the like, to communicate a series of survey ratings within implemented geo-fence parameters. The configured communication device displays a series of interactive survey rating screens to use to enter a rating for a provided service. The system receives survey ratings for compiling and displaying in real-time, and the system may also implement a predetermined time limit for completing a survey. An alert may be generated for a manager upon receipt of a rating result falling below a threshold minimum. The communication display device may be integrated with a check presenter folder such that the survey may be administered simultaneously as when the check is being tendered to the customer.

### CROSS-REFERENCE TO RELATED APPLICATIONS

This application relates to co-pending U.S. Provisional Patent Application, Ser. No. 62/341,015 filed on May 24, 2016, titled “Method and Apparatus for Collecting Survey Data”, the entire contents of which are incorporated herein by reference for all purposes.

### BACKGROUND OF THE INVENTION

### Field of the Invention

The present invention relates to administering and collecting surveys, and more particularly to a method and apparatus for collecting real-time survey data at the point of sale of a service.

### Description of the Related Art

Customer surveys are often administered in an attempt for service providers to learn more about their market, customers, potential customers, and new business opportunities. On the other hand, customers often also refer to reviews and surveys in an attempt to learn more about a business or service provider. Numerous survey platforms have been developed to allow users and customers to post feedback and reviews regarding their experiences at just about any establishment. However, there are no assurances in many of these platforms that the reviews or ratings posted regarding a certain business or establishment are by users that have actually been to the establishment or that the reviews are accurate in that they are not posted weeks after the user's initial visit. Also, many of these prior art survey platforms contain vulnerabilities to fraudulent unsatisfactory ratings to harm the business. Provided is a point of sale customer survey system that may collect feedback and reviews from customers in real-time at the point of sale. This survey system may therefore provide reviews of business establishments by people who have actually been to the reviewed establishment, and assurances that the reviews are accurate and valid in that they are taken in real-time right after the service is provided by persons with valid contact information.

### SUMMARY

Provided is a customer review platform to collect and provide real-time customer feedback at the point of sale. The review provides a survey for completion by customers rating their experience at a business premise. The review platform includes geo-fencing restrictions and time limits for completing a review to post the review in real-time. An automatic response may be generated to provide to the customer, and the survey system may provide an alert for adverse reviews not meeting a threshold minimum.

### BRIEF DESCRIPTION OF THE DRAWINGS

For a more complete understanding of the features and advantages thereof, reference is now made to the following Detailed Description taken in conjunction with the accompanying drawings, in which:

FIG. 1 shows a block diagram of a survey system for obtaining customer feedback at the point of sale;

FIG. 2 shows an embodiment for a start screen for a user to take a survey on a survey device linked to the survey system;

FIG. 3 shows an embodiment of the survey displayed on the survey device for users to quantitatively rate food quality;

FIG. 4 shows an embodiment of the survey displayed on the survey device for users to quantitatively rate their service;

FIG. 5 shows an embodiment of the survey displayed on the survey device for users to quantitatively rate the appearance of the establishment;

FIG. 6 shows an embodiment of the survey displayed on the survey device for users to quantitatively rate their experience;

FIG. 7 shows an embodiment of the survey displayed on the survey device for users to provide any comments or suggestions;

FIG. 8 shows an embodiment of the survey asking the user for identifying information;

FIG. 9 shows an embodiment of the survey asking the user for email information;

FIG. 10 shows an embodiment of the survey asking the user for mobile number information;

FIG. 11 shows an embodiment of the survey asking the user for birth information;

FIG. 12 shows an embodiment of the survey thanking the customer, providing an option to publicly post the survey feedback, and to accept an offer for information on upcoming events and discounts;

FIG. 13 shows on the survey device that the user completed the survey;

FIG. 14 shows a first embodiment of the Restaurant Operations Dashboard allowing the results of the surveys can be viewed real-time;

FIG. 15 shows a second embodiment of the Restaurant Operations Dashboard allowing the results of the surveys can be viewed real-time;

FIG. 16 shows a third embodiment of the Restaurant Operations Dashboard allowing the results of the surveys can be viewed real-time for a selected server;

FIG. 17 shows an embodiment of a Consumer website where potential customers can search for posted reviews;

FIG. 18 shows an embodiment of the Consumer website listing reviewed business based on a geographic search;

FIG. 19 shows an embodiment of posted reviews on the Consumer website of a specific example searched business; and

FIG. 20 shows a flow chart for an example embodiment of operating a survey server in the invention;

FIG. 21 and FIG. 22 illustrate a generic check presenter in an open position;

FIG. 23 illustrates an embodiment of the check presenter using a hook-and-loop fastener material restraining device;

FIG. 24 illustrates an embodiment of the check presenter using a shell restraining device;

FIG. 25 illustrates an embodiment of the check presenter using a hand-held grip holder restraining device;

FIG. 26 and FIG. 27 illustrate an embodiment of the check presenter using a magnetic restraining device;

FIG. 28 illustrates an embodiment of the check presenter using a spring-tension restraining device;

FIG. 29 illustrates an embodiment of the check presenter using an elastic band and hook restraining device;

FIG. 30 illustrates an embodiment of the check presenter using a suction cup restraining device; and

FIG. 31 and FIG. 32 illustrate an isometric and open view of a digital device integrated with the check presenter.

### DETAILED DESCRIPTION OF THE INVENTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are not considered necessary to obtain a complete understanding of the present invention, and are considered to be within the understanding of persons of ordinary skill in the relevant art.

### Consumer Survey System—Real-Time Customer Feedback at “the Origin”

A point of sale survey system is provided to collect real-time customer feedback at the point of sale. The survey system provides instantaneous feedback to the survey provider and enables the provider to immediately act on the feedback and provide better service. The survey system allows providers to capture customer experience before the moment is gone and to use that feedback for referrals, insight, and engagement. The point of sale survey system may include:
Ensuring reviews are only posted “on property”—the system may only allow reviews to be posted on premise using geo-fencing software capability and a mobile device IPS capability, or a mobile device GPS coordinate capability where the system may ensure that the coordinates of the mobile device posting the review are within “x” meters of the business coordinates or located at a known location within the business.
Ensuring a review must be submitted within a certain time frame—the system may only allow so much time to transpire between the time a sale was made and the posting of a review. The system may also allow only so much time to transpire between the start of a review and the completion of a review.
Providing an automatic response to the customer within seconds of submitting their review—the system may auto-generate a “thank you” email to the user (e.g., a restaurant's customer) once the review is submitted, where the email may be systematically sent to the reviewer within seconds of the review being submitted.
Providing an automatic instantaneous alert to the manager when a “bad” review is posted—the system may automatically generate an email (or text) alert to the manager via a trigger when a “bad” review has been submitted; because this happens almost “instantaneously,” the manager may have the opportunity to correct and remedy the situation versus potentially losing a repeat customer due to an unsatisfactory experience.

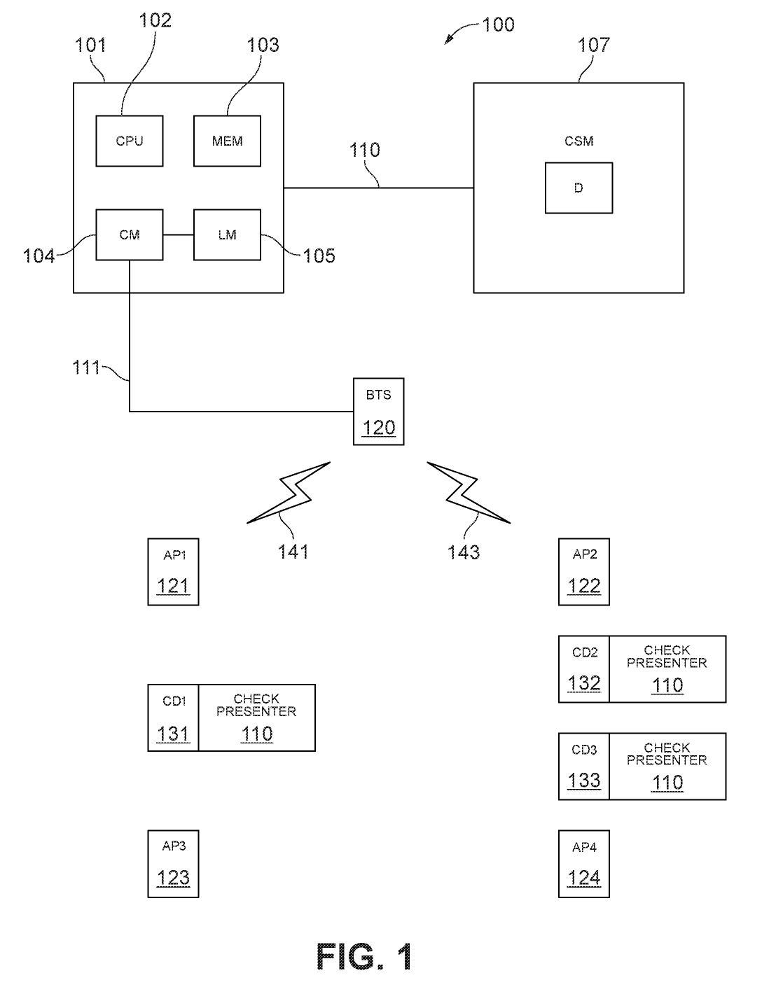

FIG. 1 depicts an embodiment of a survey system 100 that may empower providers with actionable insight by providing them with “eyes and ears” at each instant where service is being rendered. As a survey system with real-time reviews at “the origin” or point of sale, providers can immediately engage customers to ensure satisfaction. The survey system 100 may provide real-time reviews that provide actionable operational and customer engagement data that may drive increased revenue opportunities. Actionable insight may also decrease lost revenues from food or service quality issues and increase revenues from customer-focused marketing. Additionally, the survey system 100 may associate the service provide with specific wait staff to provide management with a degree of wait staff monitoring.

As depicted, the survey system 100 may include a computer survey server 101 that may be physically located on the premises. The survey server 101 may comprise a central processing unit (CPU) 102, a memory (MEM) 103, and a communication module (CM) 104, which may be associated with a location module (LM) 105. In some embodiments, the CM 104 may facilitate communication over wired or wireless communication link 111 with a base transceiver station (BTS) 120 that can receive wireless communication inside the premises. The LM 105 associated with CM 104 may analyze the wireless communication received by CM 104 to calculate/determine the originating location. Alternatively, the LM 105 functionality may be incorporated with BTS 120.

A central survey monitor (CSM) 107 may be located at the premises or at a remote location and may be connected to the survey server 101 by a wireless or wired connection 110. The CSM 107 in some embodiments may either be implemented as a conventional tablet, desk top or lap top computer system on the premises or at a remote location as a conventional desk top, lap top, tablet, or smart phone, or even on all such devices at various times and embodiments. It is contemplated that the survey system 100 may be implemented on different combinations and configurations of similar integrated computer/communication devices having a central processor unit capable of executing a software program stored on a memory storage and associated with a communication module and appropriate communication hardware and a user interface. In one embodiment, a tablet or smart phone may be provided and carried by a business manager or managers that can be programmed and function as the CSM 107, and a plurality of such computer device may be deployed by a business. Furthermore, the survey server 101 and CSM 107 may be implemented on a single, suitable computer device (e.g., desk top unit, lap tap unit, tablet, PDA, etc.).

The survey server 101 may be linked by a wired or wireless connection 111 to base transceiver station (BTS) 120. As depicted in FIG. 1, the BTS 120 may be wirelessly linked by wireless signals 141 and 143 with access point 1 (AP1) 121, access point 2 (AP2) 122, access point 3 (AP3) 123, and access point 4 (AP4). While as depicted, the BTS 120 connects wirelessly to AP1 121, AP2 122, AP3 123, and AP4 124. Alternatively, in other embodiments, wireless links 141 and 143 may be replaced by wired connections to the access points. The BTS 120 and the access points may include a processing unit configured to execute program code as well as communication hardware and software. Additionally, in other embodiments, AP1 121, AP2 122, AP3 123, and AP4 124 may be connected directly to CM 104, either wirelessly or wired, omitting BTS 120.

FIG. 1 also depicts multiple communication devices CD1 131, CD2 132, and CD3 133. Each of these communication devices CD1 131, CD2 132, and CD3 133 may include a computer processing unit coupled to a memory storing software and configured to execute software to function as a survey collection device. Each of CD1 131, CD2 132, and CD3 133 may include a graphical user interface permitting a user of CD1 131, CD2 132, and CD3 133 to complete a survey directly on a touch sensitive display screen. These communication devices CD1 131, CD2 132, and CD3 133 may include various types of computer-implemented devices configured by executed computer code into survey devices.

In operation, the access points 121, 122, 123, and 124 may function to communicate with the communication devices to facilitate the transmission of survey data collected by the communication devices 131, 132, and 133 to the survey server 101. Communication devices 131, 132, and 133 may include tablets, smart phones, PDAs, lap top computers, or the like, or combinations thereof. By using multiple access points in the survey system 100, one or more location protocols may be utilized to implement geo-fencing to restrict the posting of survey data to the premises.

Additionally, the communication/survey device 131, 132, and 133 may be integrated into a check presenter 110 that holds the bill for customers. The check presenter 110 may comprise a folder with a universal mount that allows each of the communication/survey devices 131, 132, and 132 to be retained in the folder. The communication/survey device 131, 132, and 133 may be presented to the customer in the check presenter folder 110 for tendering of the bill in conjunction with the administration of an in-restaurant survey from the survey system 100.

The computer memories in the various disclosed devices may store computer executable instructions. Each disclosed computer/communication device such as survey monitor 105 or survey server 101 may execute computer executable instructions. The computer executable instructions may be included in computer code. The computer code may be stored in the various device memories. The computer code may be written in any computer language comprising the prior art. The memory may be a non-transitory tangible storage media.

The computer code may be logic encoded in one or more tangible media or one or more non-transitory tangible media for execution by the processor in the devices. Logic encoded in one or more tangible media for execution may be defined as instructions that are executable by the processor and that are provided on the computer-readable storage media, memories, or a combination thereof. Logic may include a software controlled microprocessor, an application specific integrated circuit (ASIC), an analog circuit, a digital circuit, a programmed logic device, a memory device containing instructions, and the like. The instructions may be stored on any computer readable medium comprising the prior art from which a computer, a processor, or other electronic device can read.

The processor may include but is not limited to a general processor, digital signal processor, ASIC, field programmable gate array, analog circuit, digital circuit, central processing unit (CPU), micro-processor unit (MPU), micro-controller unit (MCU), combinations thereof, or other now known processor. The processor may be a single device or combinations of devices, such as associated with a network or distributed processing. The processor may be responsive to or operable to execute instructions stored as part of software, hardware, integrated circuits, firmware, micro-code or the like. The functions, acts, methods or tasks illustrated in the figures or described herein may be performed by the processor executing instructions stored in the memory.

The survey system 100 may be used to implement an in-restaurant survey, an internal operations dashboard that measures service and food quality in real-time, and a consumer-facing review site. Provided is an in-restaurant survey system 100 that may collect feedback and reviews from customers in real-time at the point of sale by implementing geo-fencing to restrict survey posting to the premises. Surveys may be restricted to only being collected and taken from within the restaurant. Surveys may also be restricted to being conducted in real-time with the service experience of the user such that the surveys must be taken within a pre-set time frame of the user's experience.

The survey system 100 may require that reviews and surveys be taken “on property.” This may be accomplished by only allowing reviews to be taken on-premises via geo-fencing software capability. Indoor positioning systems (IPS) may track the location of the communication device 131, 132, or 133 programmed or configured to function as a survey device to ensure that the surveys are taken at the service establishment. The IPS positioning system capability may be loaded on the survey device and operate within a Wi-Fi or Bluetooth network (or a combination thereof) within the surveyed establishment or by utilizing LM 105. Alternatively, the survey system 100 may establish location data for meeting geo-fencing requirement using an internal GPS hardware capability of the communication device 131, 132, or 133 (e.g., from a GPS circuit card/chip).

As depicted in FIG. 1, the access points 121, 122, 123, and 124 may comprise a Wi-Fi or Bluetooth “hotspot” connected with BTS 120, which may facilitate communication within survey system 100 between the survey server 101 and the communication devices/survey devices CD1 131, CD2 132, and CD3 133. The geo-fencing implementation can be crudely implemented using a large number of Bluetooth-based access points. Because of the limited range of Bluetooth—only ten meters in some applications—any user completing the survey would necessarily be located at the premises. In that sense, Bluetooth may be viewed as an indoor proximity system rather than an indoor positioning system, because it may fail to offer a pinpointed location and instead offers a general proximity solution. However, in some embodiments, a grid layout of Bluetooth access points may be implemented to provide a closer approximation to a pinpoint position solution.

The geo-fencing feature may be more precisely implemented using a Wi-Fi solution. A Wi-Fi positioning system (WPS) may be implemented by triangulation of the origination communication device using AP1 121, AP2 122, AP3 123, and AP4 124, measuring the intensity of the received signal (i.e., received signal strength), fingerprinting, angle of arrival (AoA) and time of flight (ToF) based techniques. In some embodiments, trilateration algorithms performed on the LM 105 may be used to determine the relative position of the communication devices using the fixed access point positions as a reference. Another option may use the angle of arriving signals at the access point to determine the device's location based on triangulation algorithms executed on LM 105. In other embodiments, BTS 120 may execute the necessary computer data processing to generate IPS or GPS coordinates and confirm the established geo-fence parameters.

The accuracy of the computed location may depend on the number of positions that have been entered into a database. In other words, in some embodiments, fixed positions of AP1 121, AP2 122, AP3 123, and AP4 124 may be entered into a database and stored on survey server 101 in MEM 103 or in LM 105. This may allow an accurate IPS solution to be implemented. Furthermore, the access points AP1 121, AP2 122, AP3 123, and AP4 124 may be implemented with a wireless connection to either a BTS 120 or the survey server 101. This may offer flexibility and advantages as far as scalability and installation costs/infrastructure. Such a wireless connection may also be used to communicate with widely dispersed access points, such as in an amusement park or temporary fair venue. This may avoid the expense and trouble of running fiber optic or copper cable to support wired connections at permanent or semi-permanent installations.

Alternatively, the survey system 100 may also implement a Global Positioning System (GPS) set up in the communication/survey devices 131, 132, and 133 to carry out the geo-fencing function. In such an embodiment, the survey can be limited to the GPS coordinates corresponding to the immediate proximity of the premises. That is, the communication devices 131, 132, and 133 may be implemented using their integrated GPS location technology to effect geo-fencing by communicating GPS location to the survey system 100.

The communication/survey devices 131, 132, and 133 may be provided by the restaurant/business and programmed to enable a user to complete the survey on the premises. Such mobile devices may comprise a business-furnished tablet or similar computer device with a touch-sensitive display screen. However, in many embodiments, it is contemplated that the communication/survey devices 131, 132, and 133 may be customer-provided mobile devices such as a tablet, smart phone, lap top or the like. In some embodiments, the survey devices may comprise a personal digital assistant (PDA) such as, in one specific example, a tablet (e.g., an iPad) or the like provided by the business. The mobile device may interface with the survey system 100 via a communication application downloaded from the survey system 100, downloaded from a website, or performed using a website, or done using a locally established communication session to directly interface with survey server 101. The survey may then be completed using a Wi-Fi, Bluetooth, or WLAN communication protocol. In some embodiments, the communication/survey devices 131, 132, and 133 may be implemented on a business-provided device (e.g., tablet or PDA) programmed and configured as a check payment device, configured to display a bill, accept a credit card for payment, and present a survey and accept survey entries.

The communication/survey devices 131, 132, and 133 may operate without or without a connection to the survey system 100. Should connection between the communication/survey devices 131, 132, and 133 and the survey system 100 be temporarily disconnected, the communication/survey devices 131, 132, and 133 may initially store data from completed surveys locally on the communication/survey devices 131, 132, and 133 itself. The communication/survey devices 131, 132, and 133 may automatically upload the results of any locally stored surveys when connection between the communication/survey devices 131, 132, and 133 and the survey system 100 is restored.

To ensure that surveys are taken in real-time, the survey system 100 may be configured to only accept reviews submitted within a certain time frame. Configurations may be set up such that reviews must be completed within a set amount of time once a customer starts the review survey (e.g., 20 minutes). Alternatively, a review or survey may be configured to be tied to a specific sales transaction where the survey must be completed within a certain time once the sale has been completed. The surveys may also be further tied to a specific employee/wait staff.

Another aspect of the survey system 100 may provide automatic responses to customers after the submission of review. Customers may receive “thank you” emails from the service provider or a text on a cell phone/smart phone or other communication device. The “thank you” acknowledgement message may also serve to confirm receipt of the survey by the system 100 as well as provide confirmation that the survey is associated with a valid email address and/or mobile number. If the system 100 receives an indication that the email or mobile number is not genuine, the survey results may be noted as fraudulent and/or deleted from system 100. An identical or similar message may be displayed on the survey device. The service provider may also use this opportunity to promote their business by informing the user of upcoming promotions or specials.

Another aspect of the survey system 100 may provide real-time, actionable feedback at the moment of service. The survey system 100 may provide an instantaneous alert to a manager when a “bad” review is posted from a user or customer. This real-time notification may give management time to immediately act on the customer's comments and salvage a potential repeating customer. The real-time notification aspect to service providers may increase opportunities for customer engagement, provide actionable insight, and increase revenue opportunities.

Surveys may be administered by service providers using their mobile communication device configured as a survey device. Survey devices may comprise any general computing device including but not limited to phones, smart phones, tablets, PDAs, readers, laptops, computers and the like. The survey devices may be configured by executed computer code to display a series of interactive survey screens for entering one or more survey ratings of a customer experience. The ratings may qualitatively record a customer's opinion as to a service received, broadly reflecting a rating ranging from “poor” to “excellent” as to a specified service.

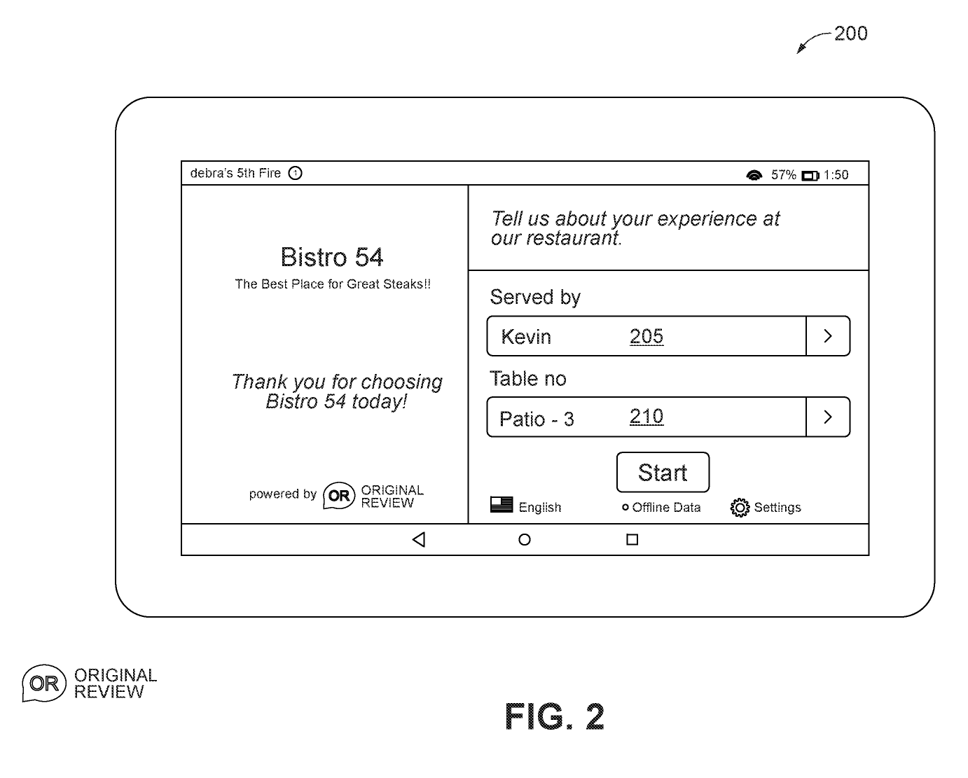

Turning to FIG. 2, an embodiment of the survey format is shown beginning with the start screen 200 for a customer to initiate the survey. Start screen 200 may be tailored with specific data such as the server, table number, time and date of visit, size of party, and the like, to create additional qualitative and quantitative analysis with the collected data. In the example shown, the start screen 200 of the survey shows the server 205 that served the user taking the survey and the location 210 of the user at the establishment.

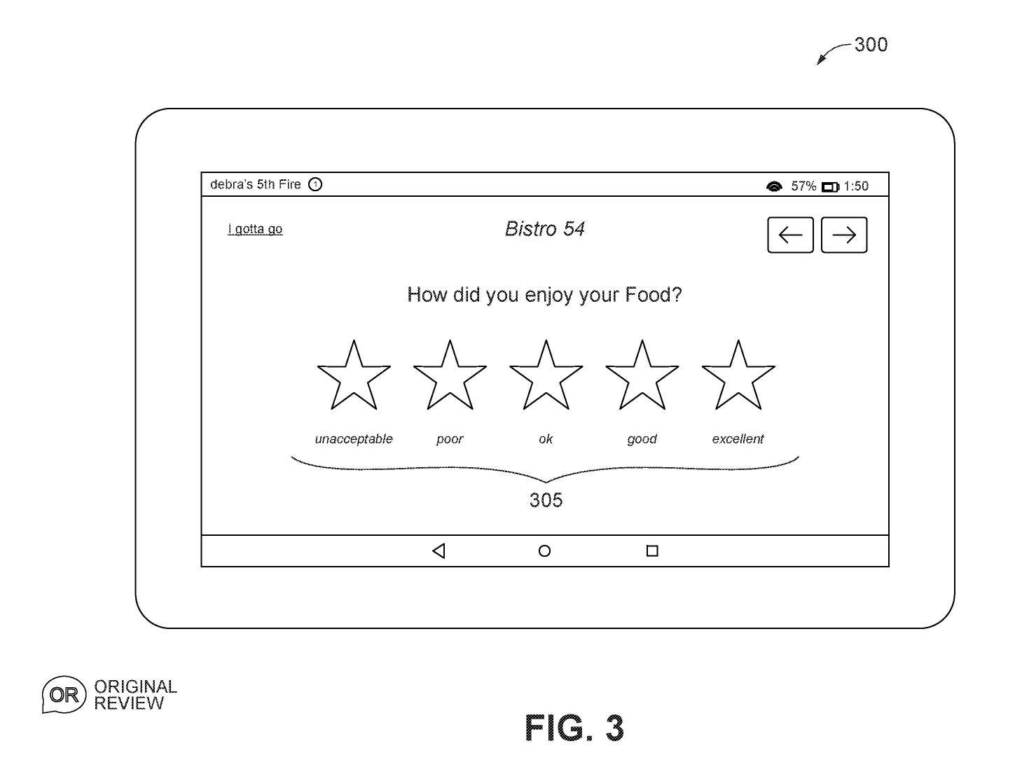

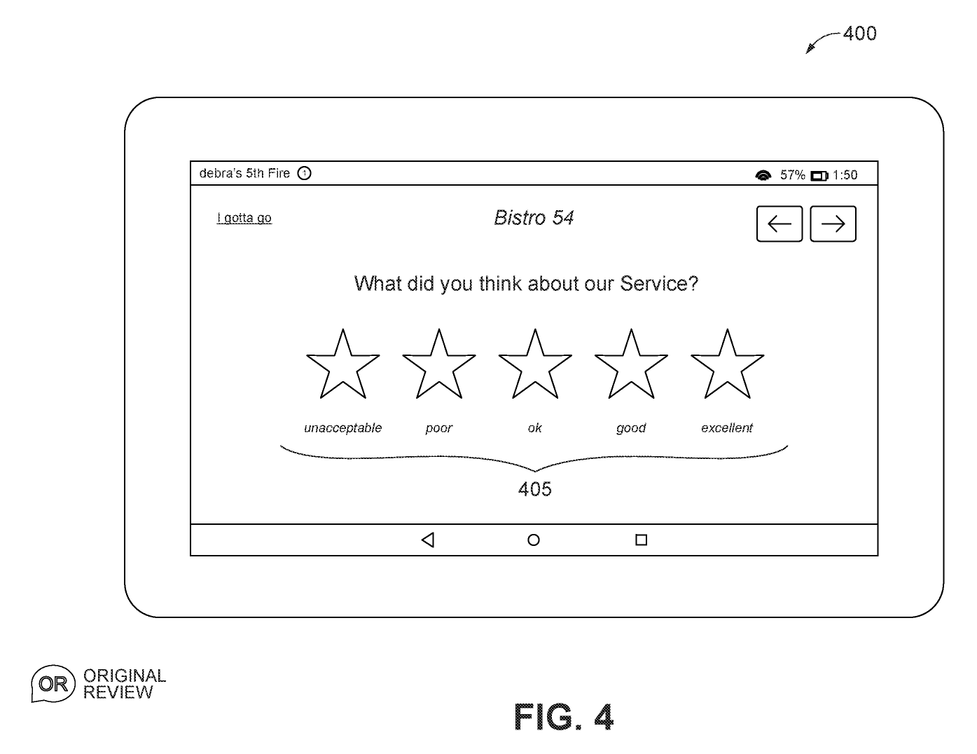

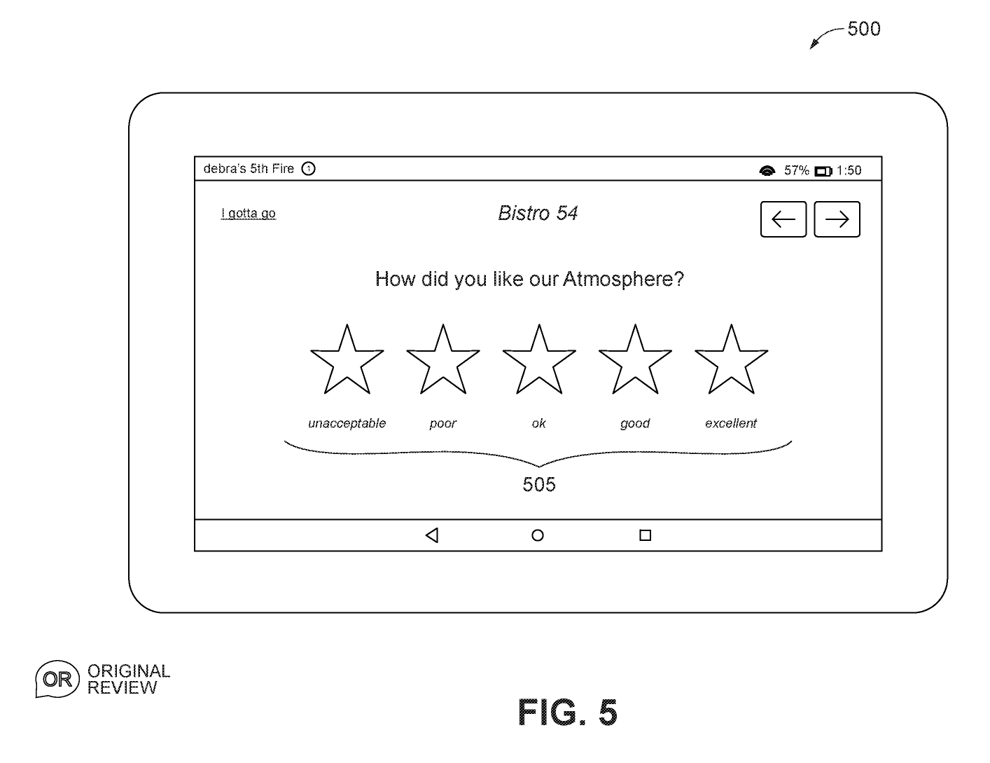

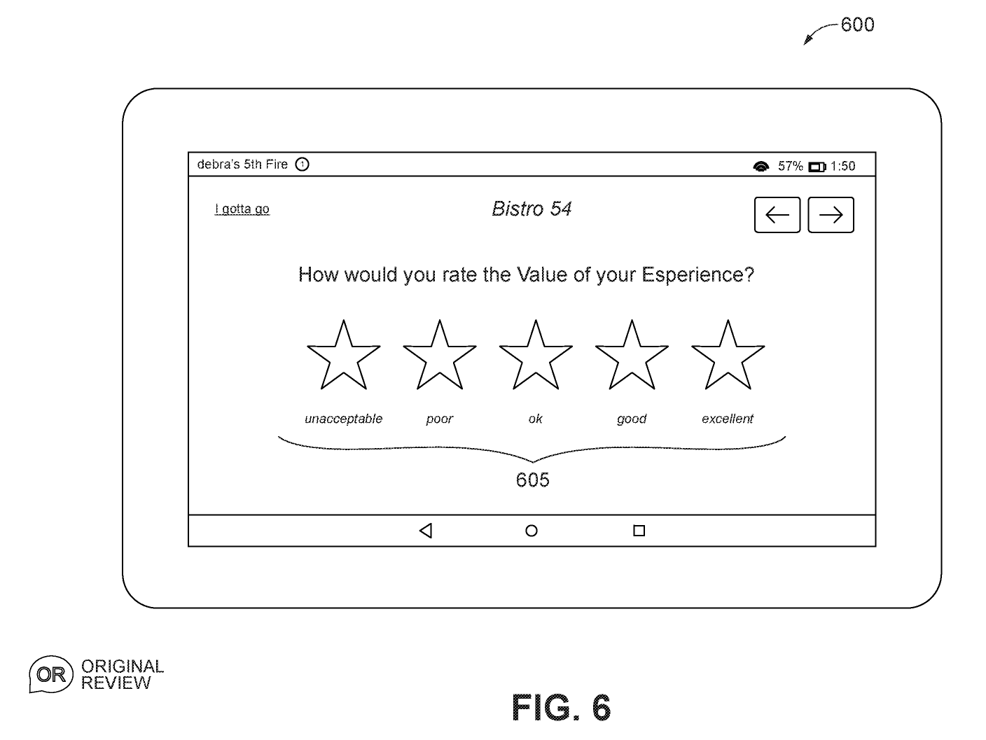

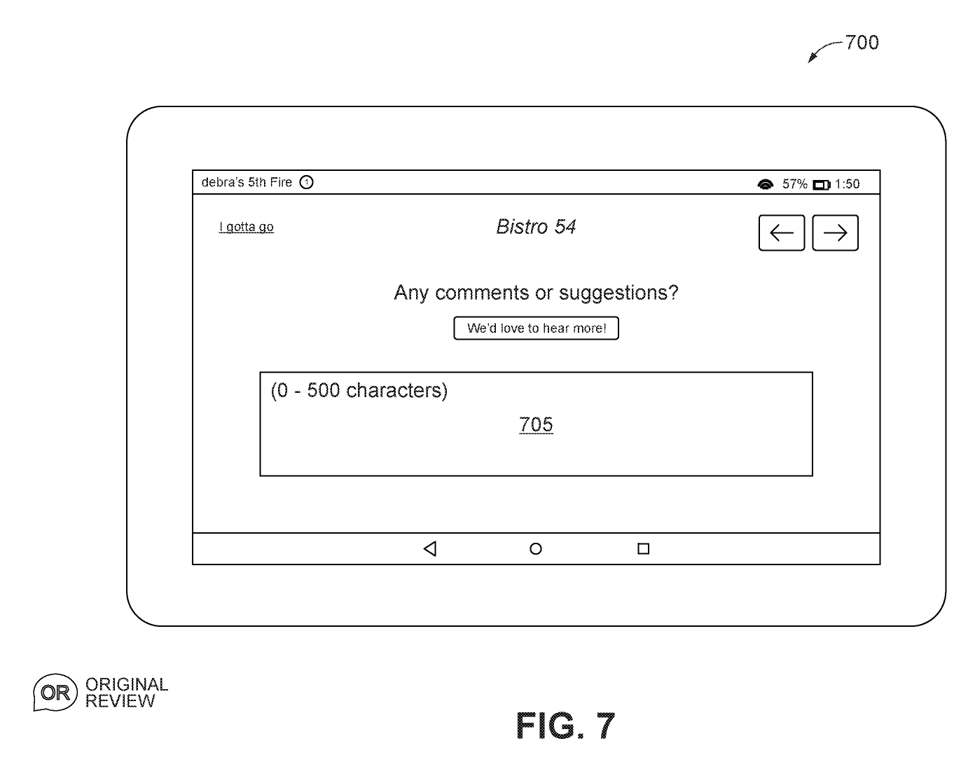

Turning to FIG. 3, FIG. 4, FIG. 5 and FIG. 6, exemplary survey screens show example questions of the survey that inquire the survey taker about their experience at the service establishment. As shown in FIG. 3, examples of questions asked may include a food survey screen 300 to rate the food the user just had at the establishment with food ratings 305. In FIG. 4, the survey taker may be asked on a general service survey screen 400 to rate the experience they just had at the establishment with experience ratings 405. In FIG. 5, the survey taker may be asked about their opinion on an atmosphere survey screen 500 by providing atmosphere ratings 505. In FIG. 6, the survey taker may be asked about the value of their experience with value ratings 605 on value survey screen 600. A survey taker may respond to each of these question using qualitative ratings such as unacceptable, poor, ok, good, and excellent as shown at 305, 405, 505, and 605. Alternatively, the survey may ask the user to respond to the questions using quantitative ratings by choosing a number between one (1) through five (5), with a notation indicating 1 being the worst and 5 being the best. Other possible ratings may be expressed to convey a survey takers ratings to broadly provide ratings falling between “unacceptable” and “excellent.”

FIG. 6 shows the survey system 100 asking the survey taker whether they have any comments or suggestions on comment screen 600. Customers may use this section 605 to provide specific suggestions, feedbacks, comments, or complaints to a service provider regarding certain experiences that may be unique to their visit.

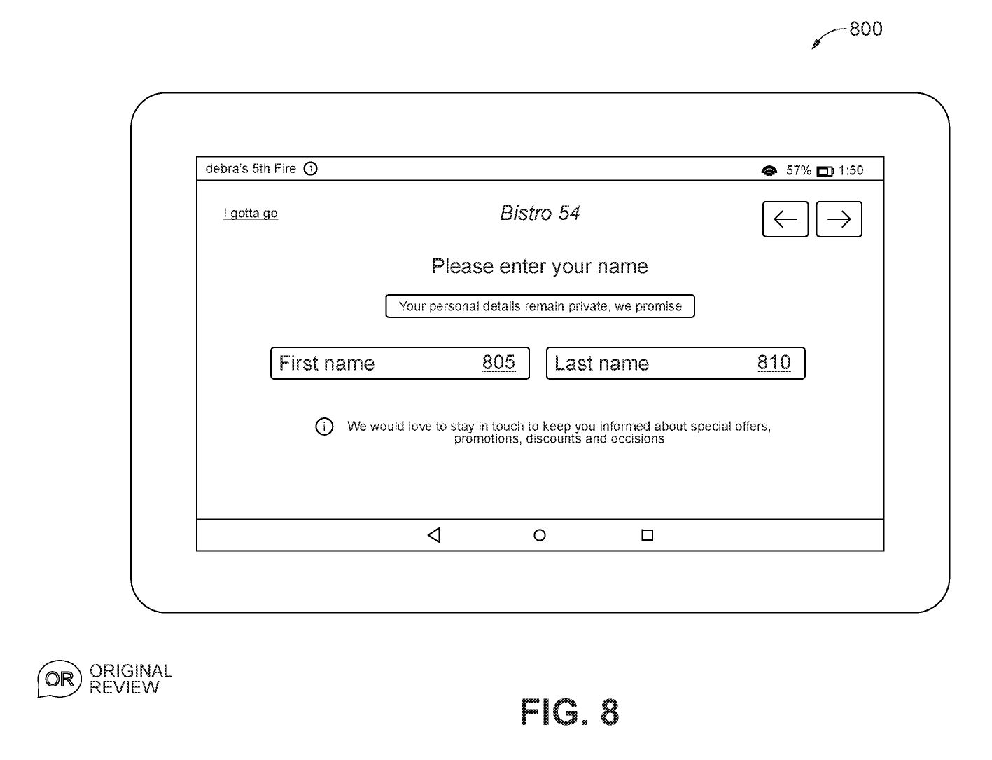

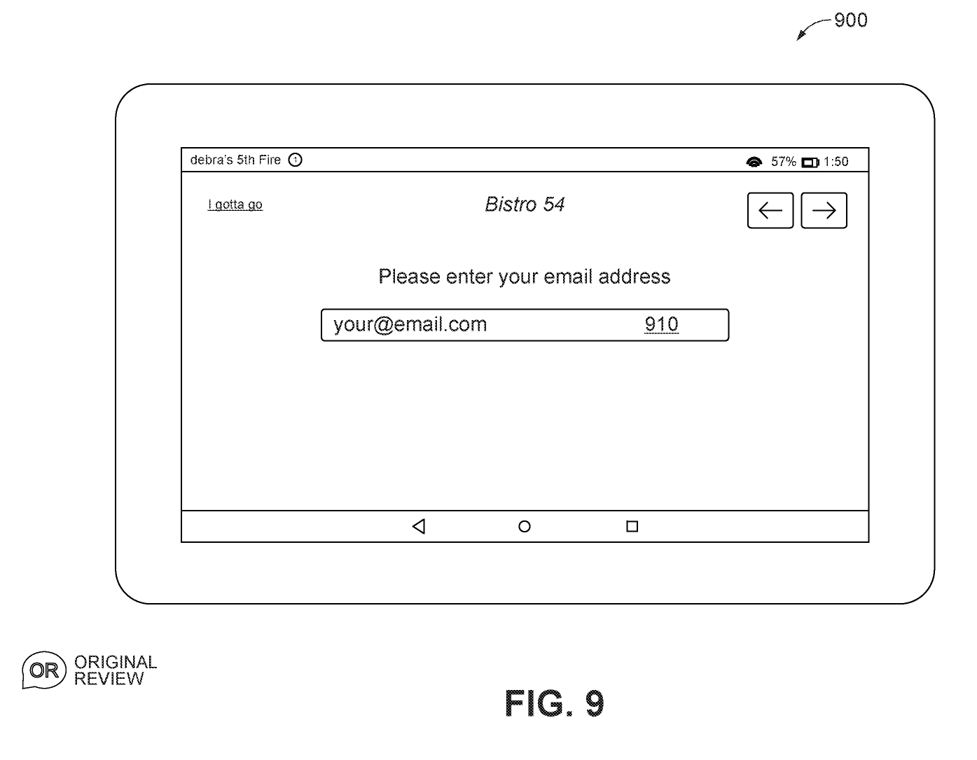

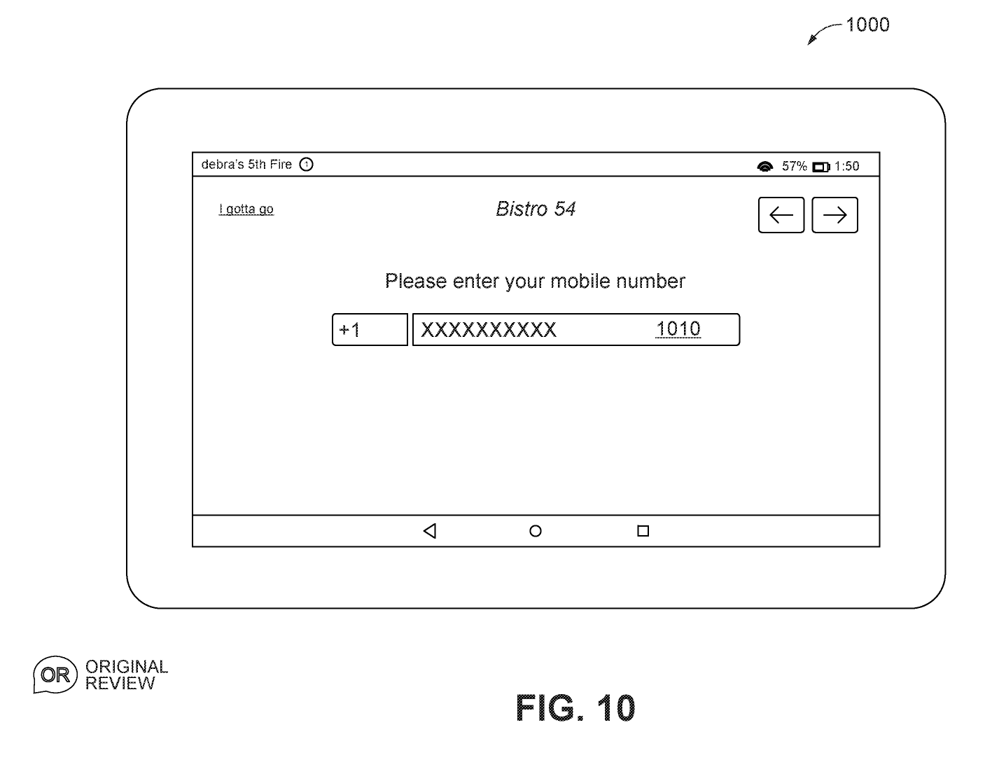

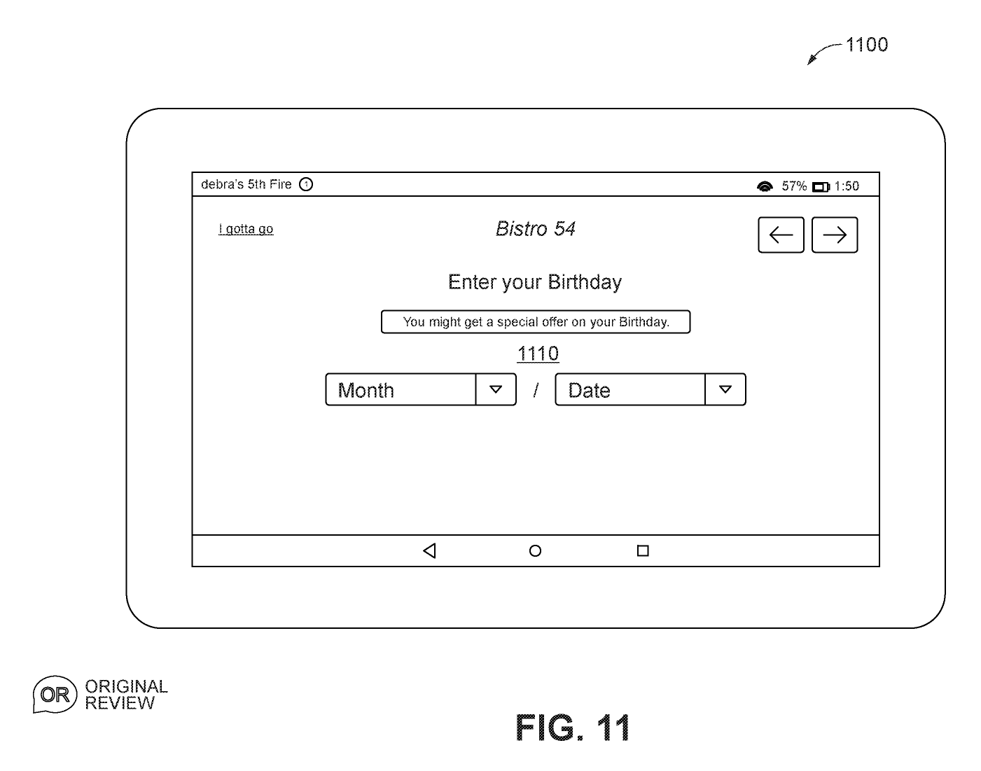

Turning to FIG. 8, FIG. 9, FIG. 10 and FIG. 11, the survey screens of the survey system 100 may ask the survey taker to provide identifying and contact information that may be used to create a personal profile. In FIG. 8, a survey taker may enter identifying information 800 such as their first name 805 and last name 810. In FIG. 9, the survey may allow a survey taker to enter contact information 900 such as an email address 910. In FIG. 10, the survey may allow a survey taker to enter a telephone number 1000 such as a mobile number 1010. FIG. 11 provides a survey screen to enter other personal information 1100 such as a birthdate 1110.

Business providers may use the information collected by the screens depicted in FIG. 8, FIG. 9, FIG. 10 and FIG. 11 to reach out to specific customers regarding their experience. The survey system 100 therefore may create additional opportunities for service providers to engage potential customers even after their visit to generate additional business opportunities. Coupons, event notices, or other marketing can be communicated to customers using the collected data. The information may also validate that contact information collected reflects a “real” survey taker and not fake entries reflecting malicious intent.

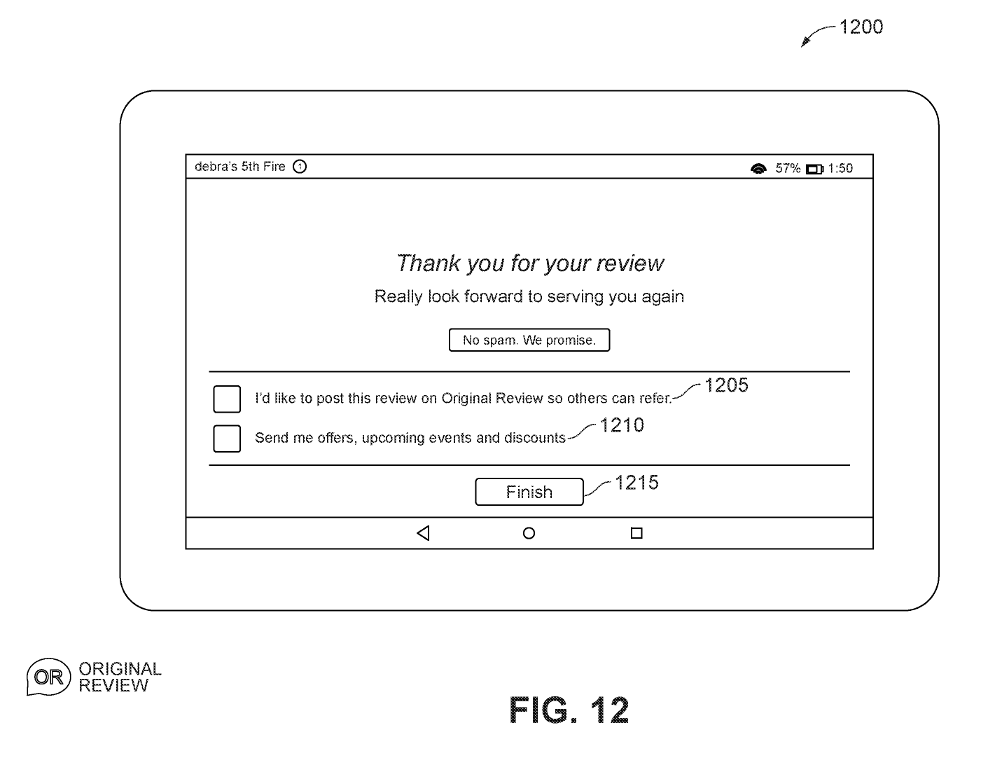

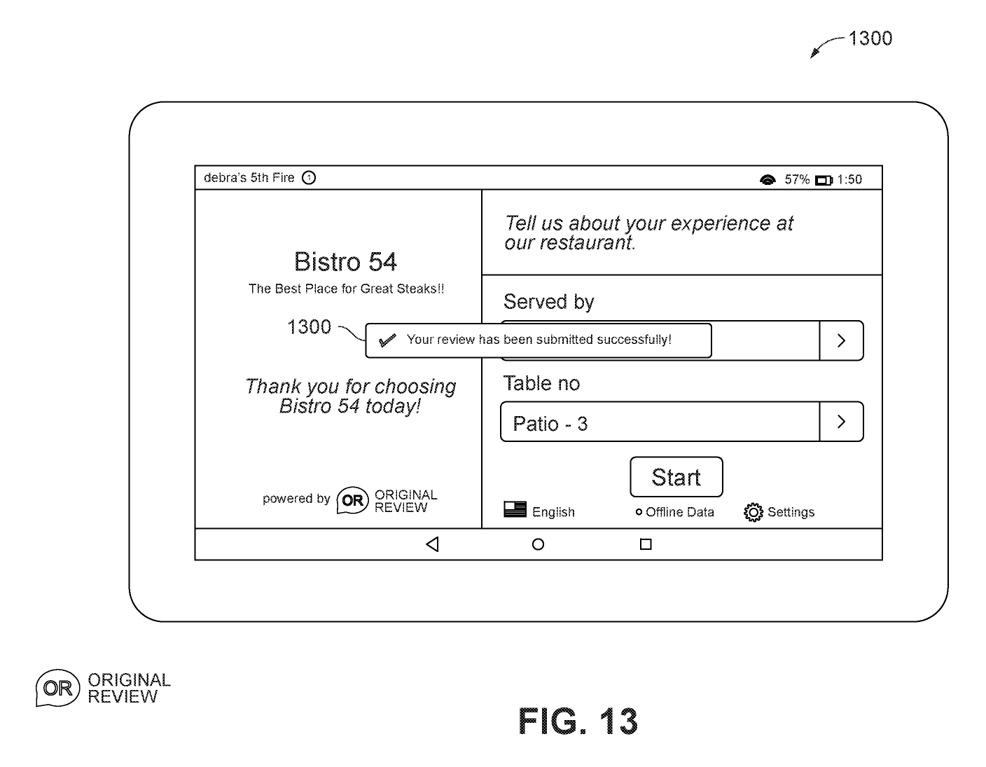

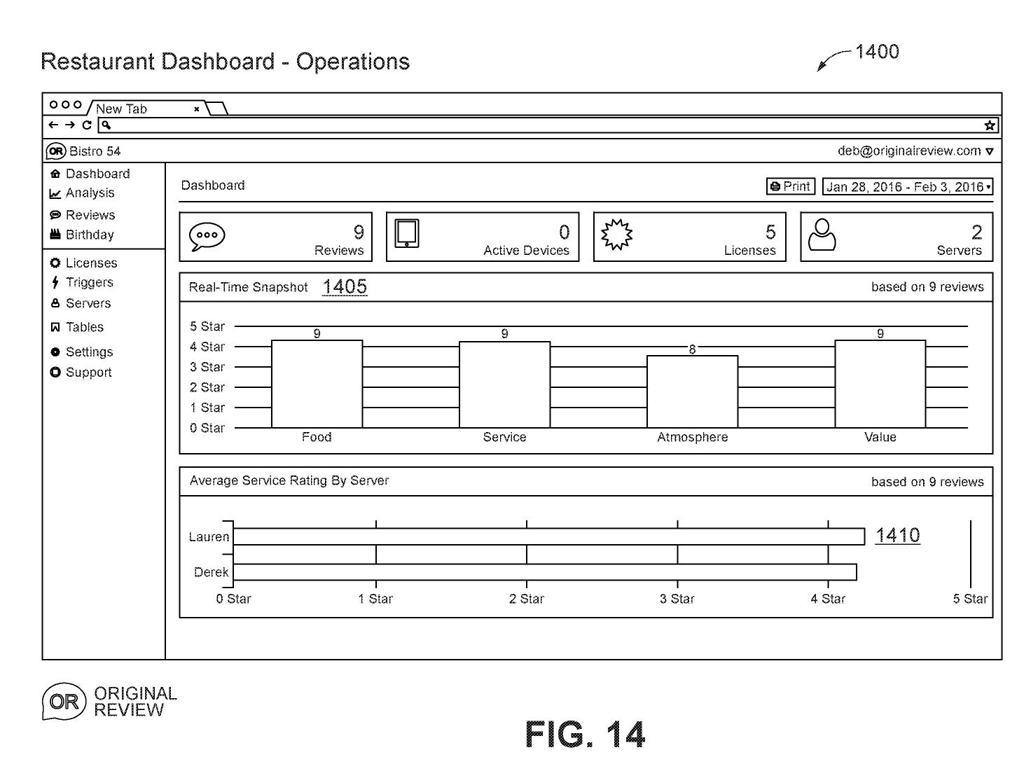

FIG. 12 and FIG. 13 show a completion screen after the survey taker has completed the survey. In the embodiment shown in FIG. 12, a completion screen 1200 of the survey system 100 may ask the taker for permission to post the review 1205 for others to refer. The completion screen 1200 may also provide an opportunity for customers to indicate whether the survey taker desires the service provider to use the provided contact information to contact the survey taker to send offers, info on upcoming events, and discounts 1210. Alternatively, the survey system 100 may be configured such that all reviews may be posted so as to prevent bias with regards to the reviews available for consumers to refer. Finally, there may be a finish icon 1215 to select to indicate the survey taker has finished completing the screen 1200 as a final finishing act. As shown in FIG. 13, the survey system 100 may depict a final completion screen 1300 confirming receipt of the submitted review 1305.

The survey system 100 may equip service providers with an Internal Operations Dashboards where the results of surveys may be monitored in real-time by a manager or an administrator. The Internal Operations Dashboard may be web or cloud based such that the Internal Operations Dashboards may be viewed in real-time from anywhere in the world with a web browser. Information gathered and displayed on the Internal Operations Dashboard may be secured and private available to only designated administrative or management personnel within the organization.

In an embodiment, the reports available through the internal operations dashboard may include but is not limited food, service, atmosphere, value over any time period (day, week, month, custom range), server analysis, performance analysis, and the like.

FIG. 14 depicts an example of the restaurant operations dashboard 1400 displaying the real-time average of reviews already administered 1405. The internal operations dashboard 1400 may be configured to show real-time analysis of the ratings currently being given for each of the questions administered to customers. The real-time data therefore provides actionable insight such that management can immediately look into what is causing a less than satisfactory experience and remedy it. The actionable data may allow immediate improvements to be made and prevent additional harm from being done that may result in further loss of business or revenue. Additional metrics that may be provided by the dashboard include the average rating organized by identified servers 1410. Specific feedback on service may motivate service staff to provide better service.

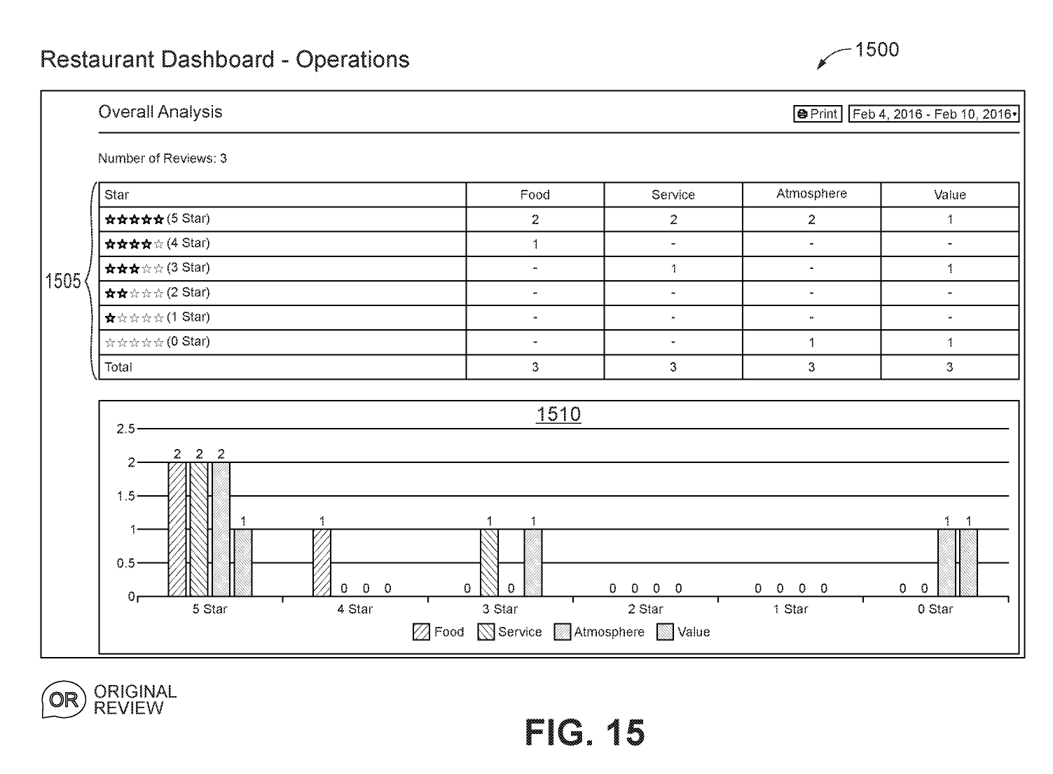

FIG. 15 shows examples of additional analysis and metrics that may be generated using the data collected from the surveys in an analysis screen 1500 of Internal Operations Dashboard. The operations dashboard depicted in FIG. 15 may provide managers with real-time snapshot of the ratings for each of the separate questions given on reviews such as table 1505. The data may be presented on the dashboard in multiple forms such as tables, graphs, charts, and the like. For example, a bar graph 1510 of the results of the survey is also depicted. For ratings not meeting a threshold minimum, an alert may be generated and delivered to a manager for immediate consideration and an opportunity to immediately address.

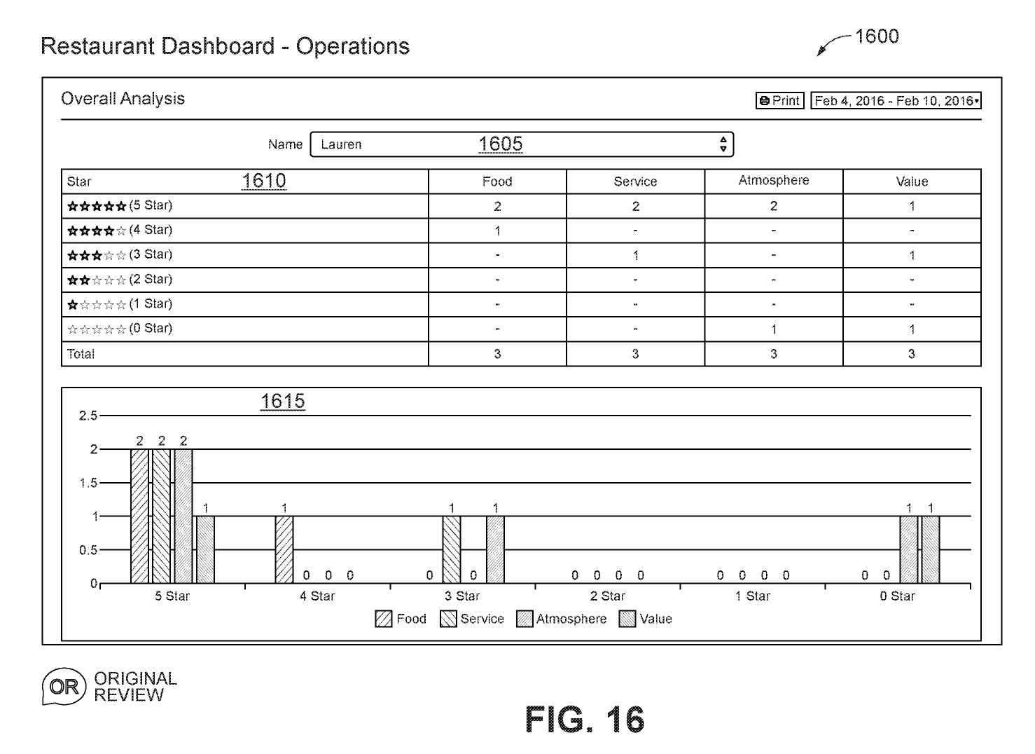

FIG. 16 depicts an embodiment of an Internal Operations Dashboards 1600 displaying analysis of metrics applicable to an identified server shown in 1605. As depicted, a table of survey ratings results 1610 displays ratings corresponding to specific server “Lauren.” As depicted, a bar graph of survey ratings results 1615 repeats the rating from table of survey results 1610 in real-time.

### Consumer Review Site

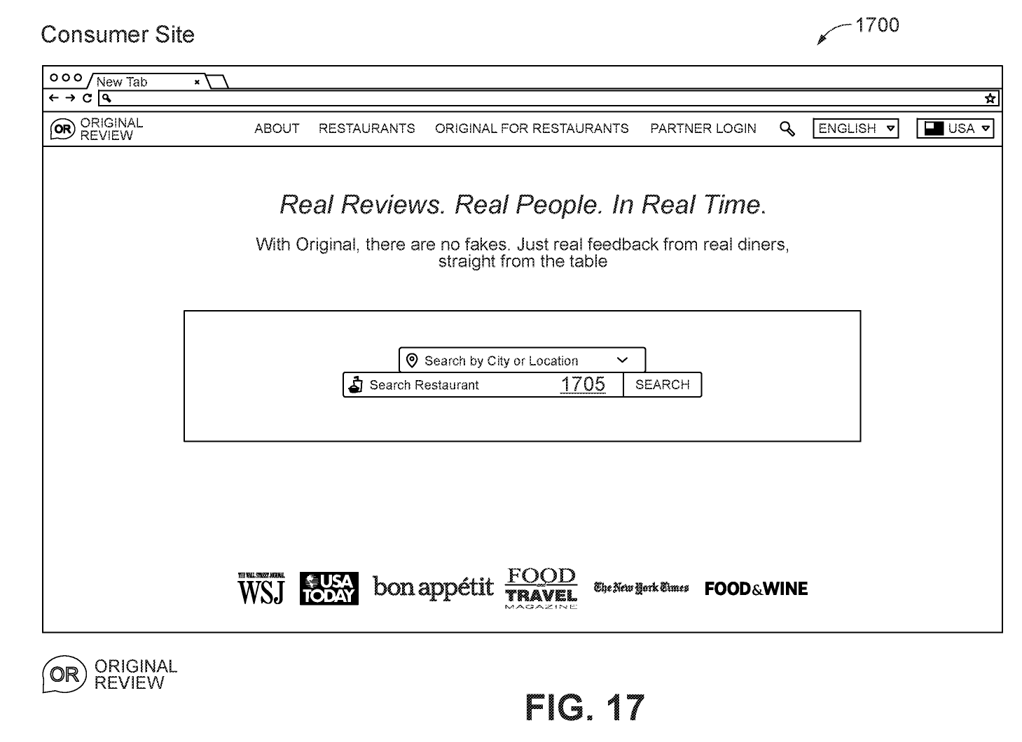

Consumers may also benefit from the real-time reviews through a Customer site on the Internet where reviews from surveys taken are posted. FIG. 17 depicts an example of a Customer website where potential customers may view posted reviews based on specific business locations and establishments. The website may host a searchable database containing survey results from multiple businesses. The database may be populated by survey data stored on memory 103 or another memory associated with survey server 101. The website itself may also be hosted on survey server 101. Customers may also search for already reviewed businesses based on geographic locations, such as a search by city, state, or zip code. As depicted, review screen 1700 shows an example of an option to search a listing of reviewed restaurants based on a search option by geographic location 1705.

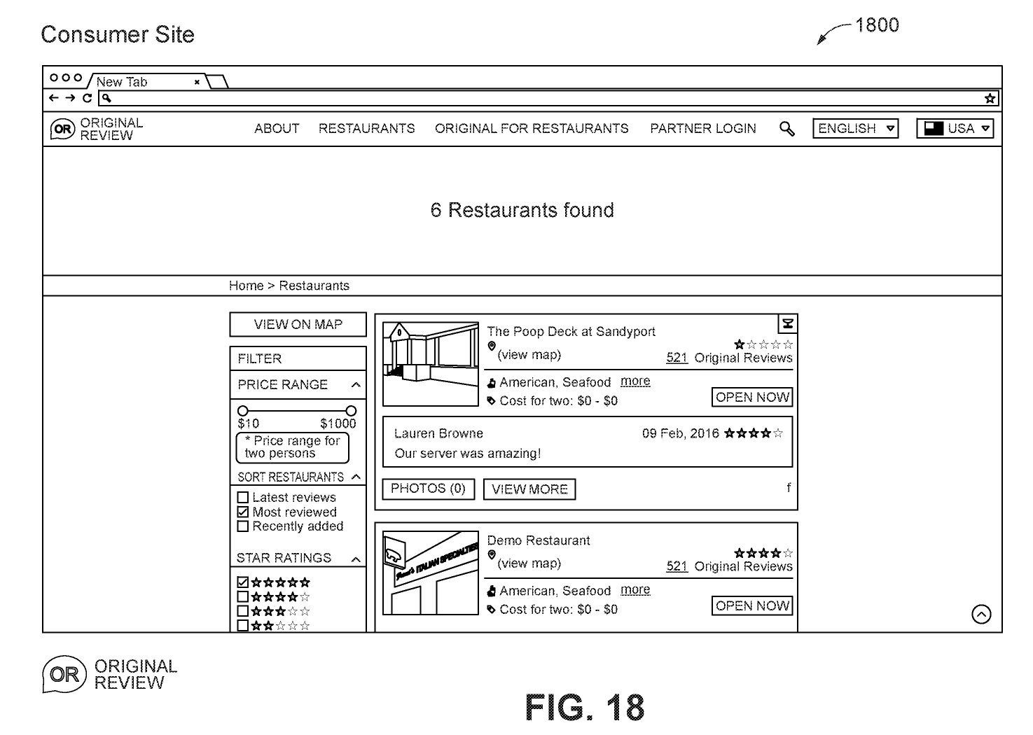

The Customer site may provide a central hub where multiple reviews may be culminated to allow consumers to view the real-time ratings, reviews, and feedbacks for each service establishment. This data may be retrieved from memory stored on memory 103 associated with survey server 101 as shown in FIG. 1. As depicted in FIG. 18, rating screen 1800 shows an example of posted review ratings for two reviewed businesses. Potential customers viewing the Customer site may look at both comments posted by reviewers as well as the ratings posted by the reviewer. The ratings may be organized as a culmination of multiple reviews, individual reviews, or a combination of the two.

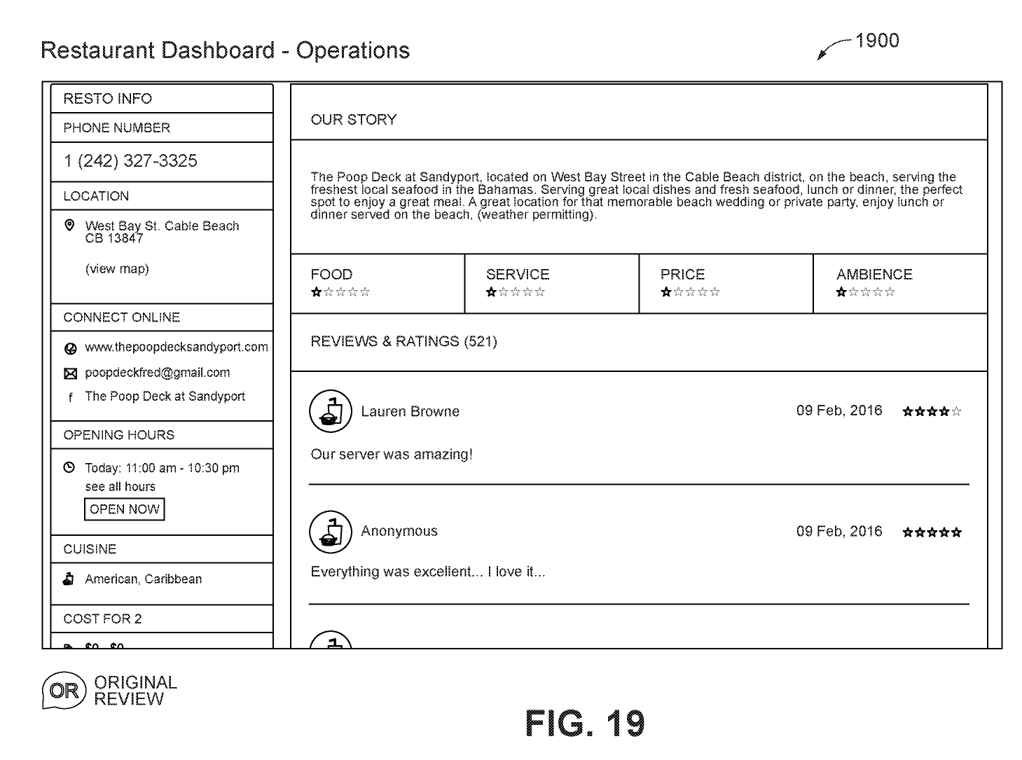

With the real-time survey system 100 administered only at the point of sale, viewers of the Customer site may be assured confidence that the ratings, reviews, and feedbacks for each service establishment on rating screen 1800 are real reviews by real people where the reviews are taken in real-time at the service establishment. The Consumer site may therefore rewards service providers that provide excellent service by indicating to potential customers the excellent service similar customers in the past have received. Turning to FIG. 19, a restaurant information screen 1900 displays information specific to a restaurant selected on rating screen 1800.

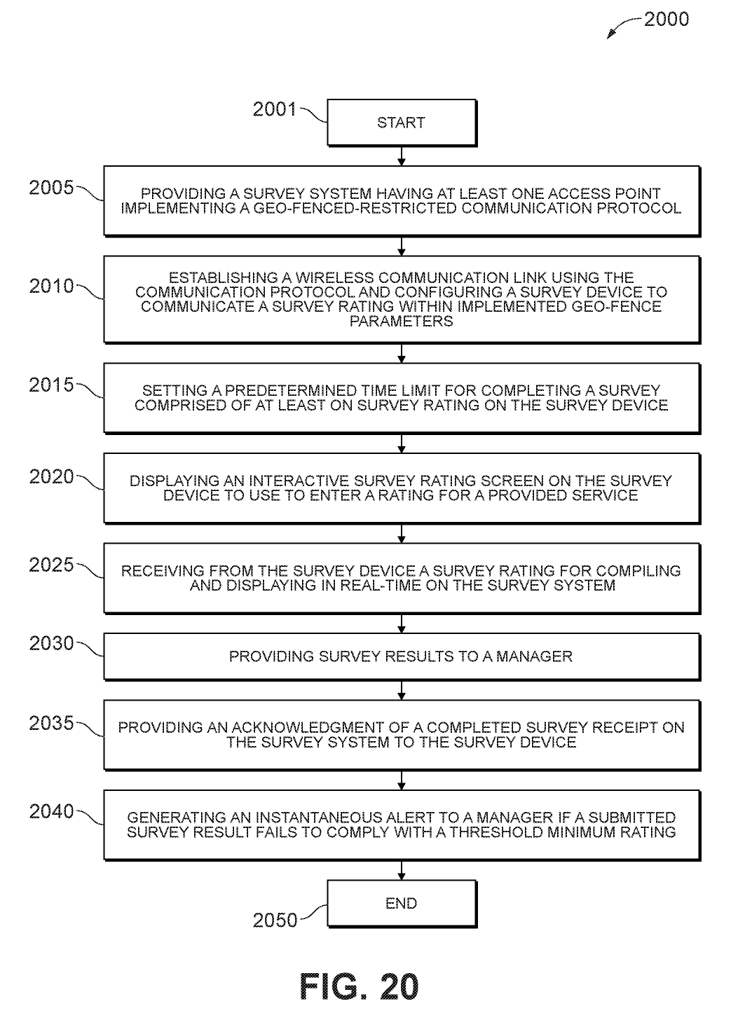

Turning to FIG. 20, in an embodiment, a flow chart 2000 is provided showing a method for operating the survey system 100. The method may start at step 2001. In step 2005, the method may begin by providing a survey system 100 having a display device and at least one access point implementing a geo-fenced-restricted communication protocol. The geo-fencing protocol may ensure the survey is completed on-site by restricting communications within a designated area. The method may then proceed to step 2010 with the survey system 100 establishing a wireless communication link using the communication protocol and configuring a survey device to communicate a survey rating within the implemented geo-fence parameters. The system 100 may interface with a communication/computer device and configure the communication/computer device to display interactive survey screens that a user can record ratings into the survey and transmit the ratings to the survey system 100. Alternatively, the survey device may make entries into a survey by directly interfacing with a survey server 101 of the system 100.

As part of configuring the survey device, in step 2015, the method may include setting a predetermined time limit for completing a survey. The survey itself may comprise at least one survey rating entered on the survey device within the time limit on an interactive screen. In step 2020, the method may include displaying an interactive survey rating screen on the survey device to use to enter a rating for a provided service. The method may then proceed to step 2025 to receive from the survey device a survey rating for compiling and displaying in real-time on the survey system 100. The may be done on the CSM 107 as depicted in FIG. 1 or on some other display device associated with the survey system 100. In step 2030, the survey system 100 may provide survey results to a manager to enable the manager to take immediate corrective action and prevent possible loss of a future customer. In some embodiments, the survey results may be displayed on CSM 107, but in others, the results may be communicated and displayed to the manager on a separate communication device such as a smart phone, tablet, PDA, or the like instantaneously in real-time or periodically. The results may be displayed automatically or selectively retrieved by the manager.

At step 2035, as depicted, the survey system 100 may provide an acknowledgement of a completed survey receipt on the survey system 100 to the survey device. The acknowledgement may confirm receipt of the survey submitted on the survey device on the survey system 100 and entry into a survey database that may be stored on the survey server 100 or other memory associated with the survey system 100. In step 2040, the survey system 100 may generate an instantaneous alert to a manager if a submitted survey result fails to comply with a threshold minimum rating. This alert may allow the manager to take immediate action to address the sub-satisfactory rating with the customer and prevent loss of future return visits. The manager may be able to thus change a negative customer experience to a positive one and ensure future visits. The alert may be audible. The method may end at step 2050.

### Check Presenter

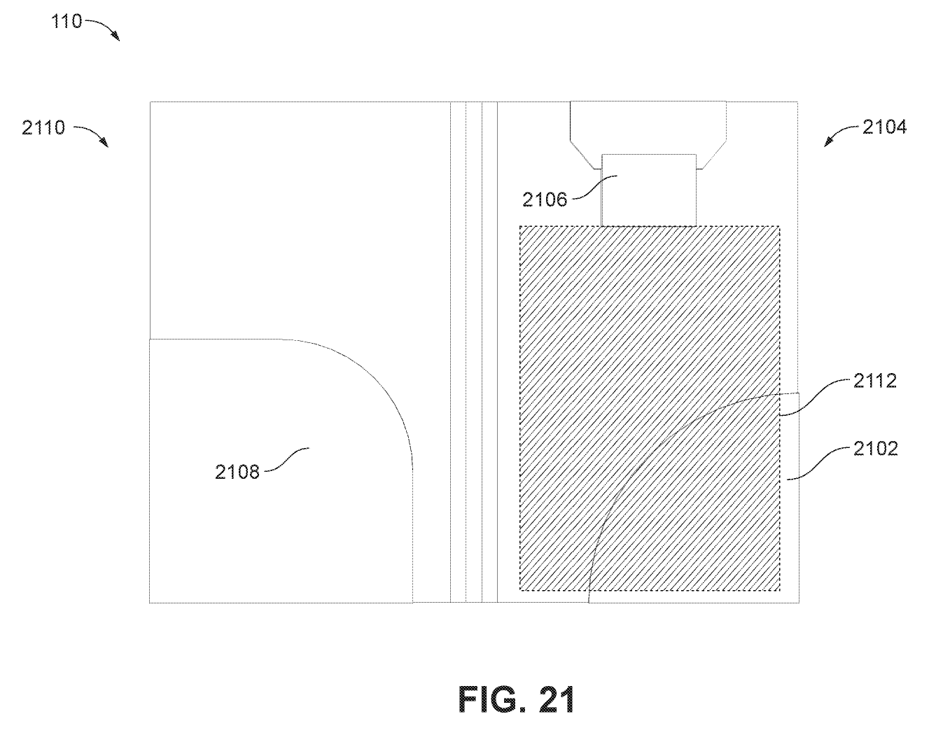

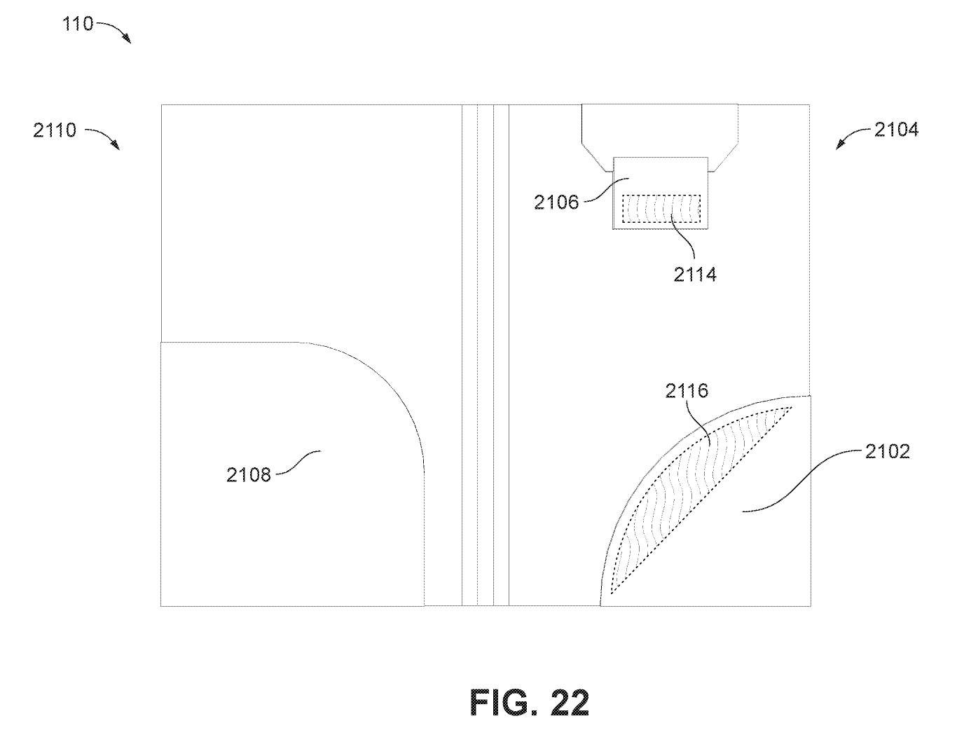

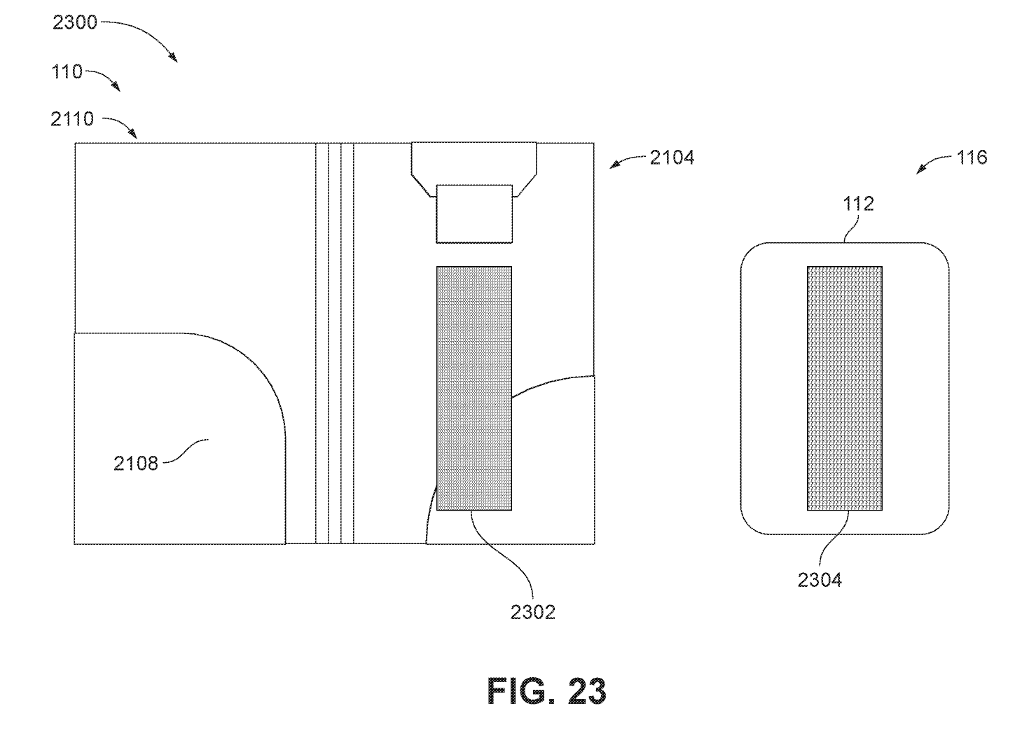

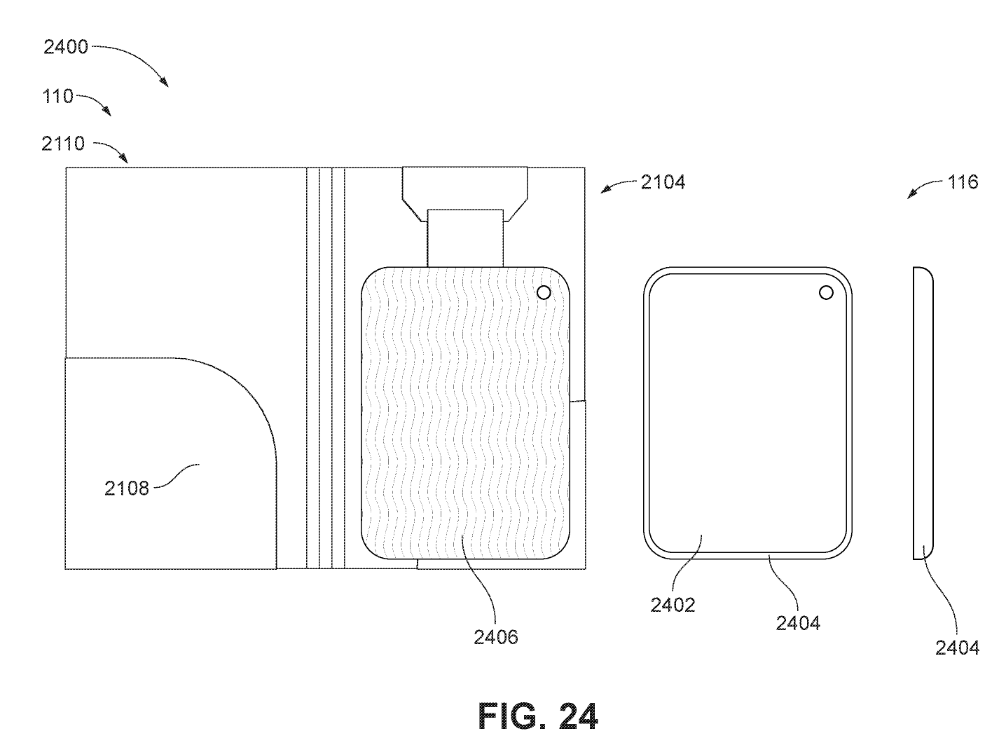

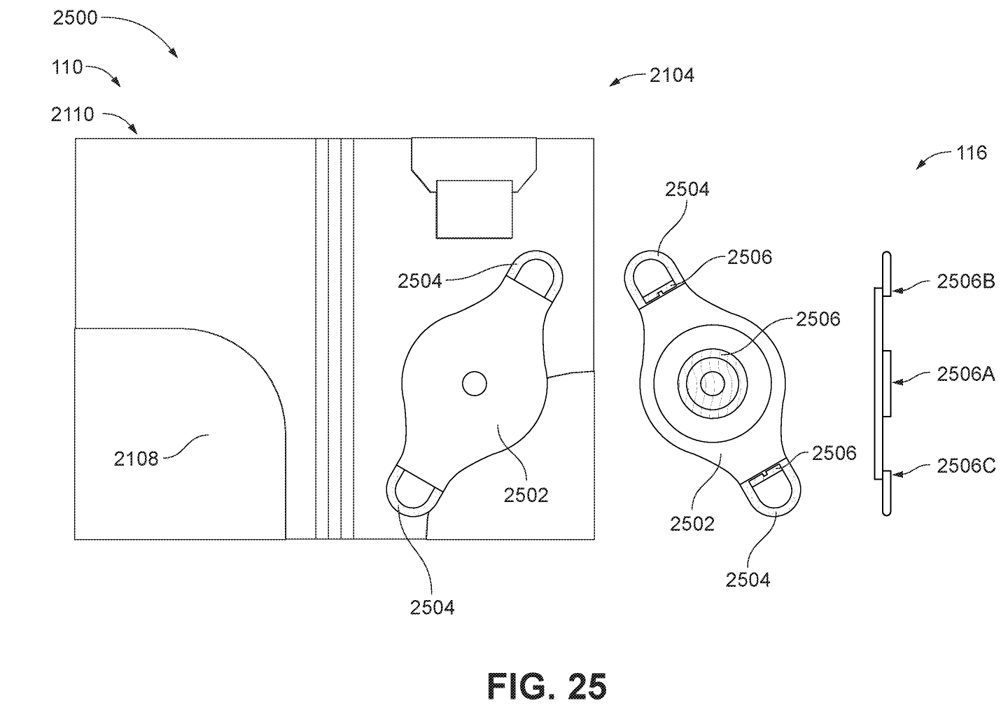

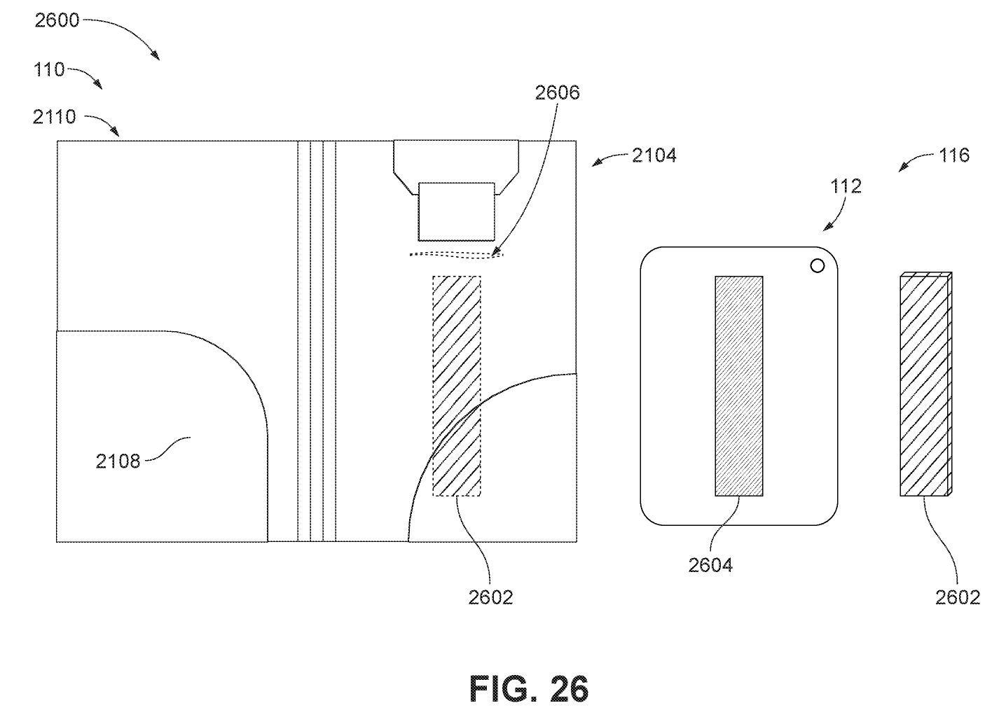

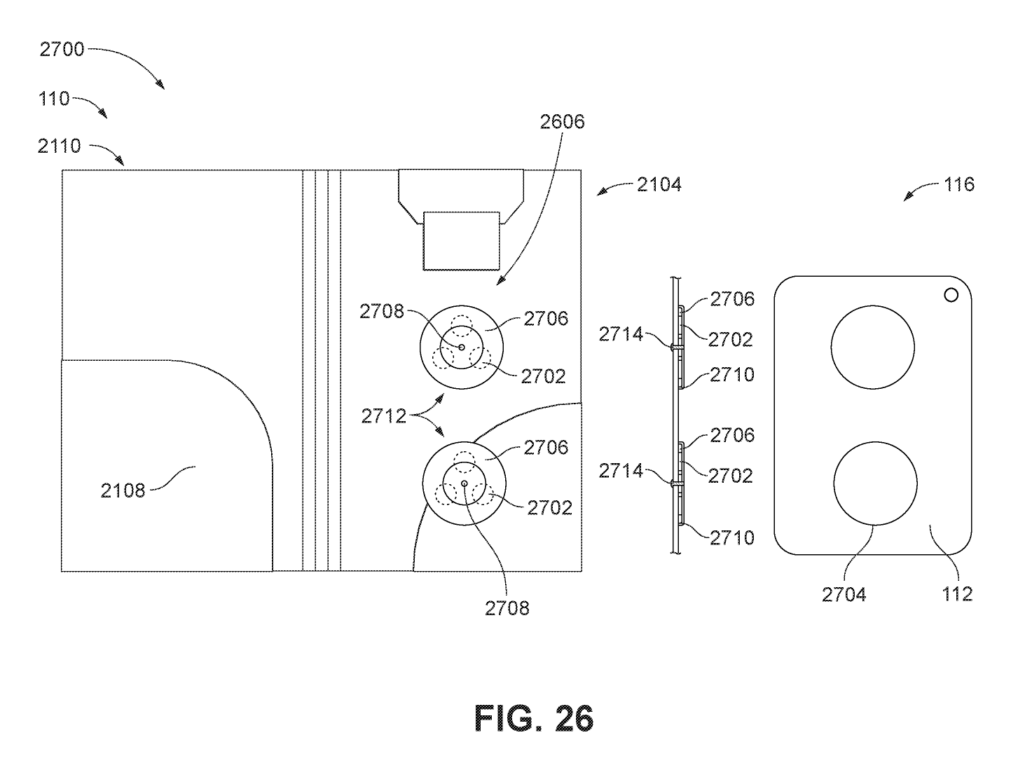

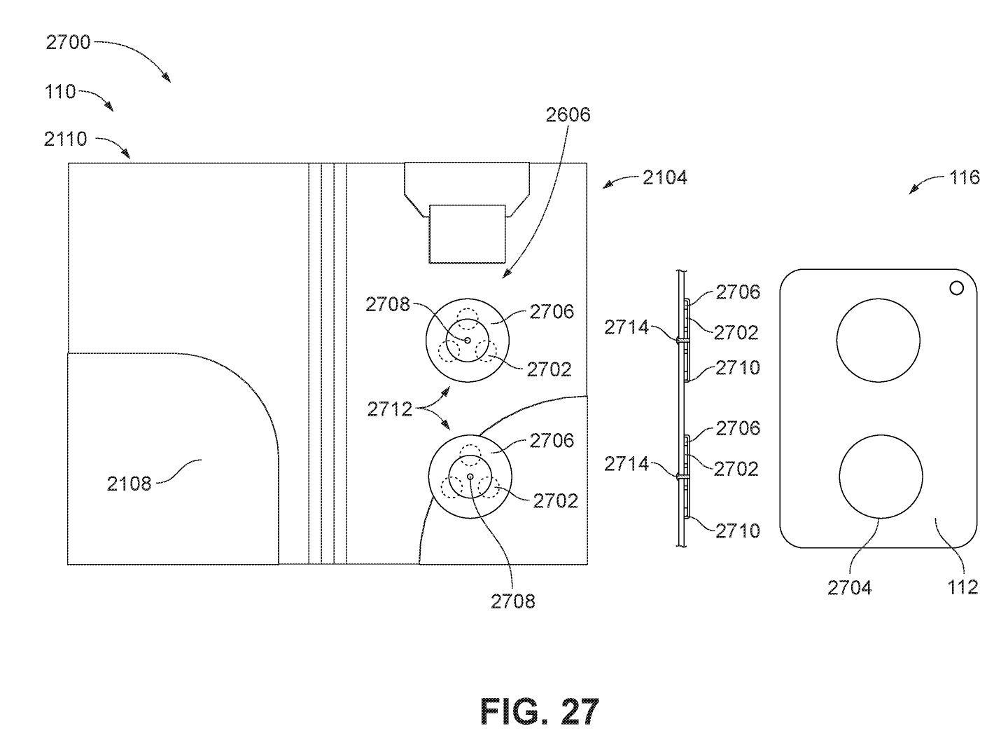

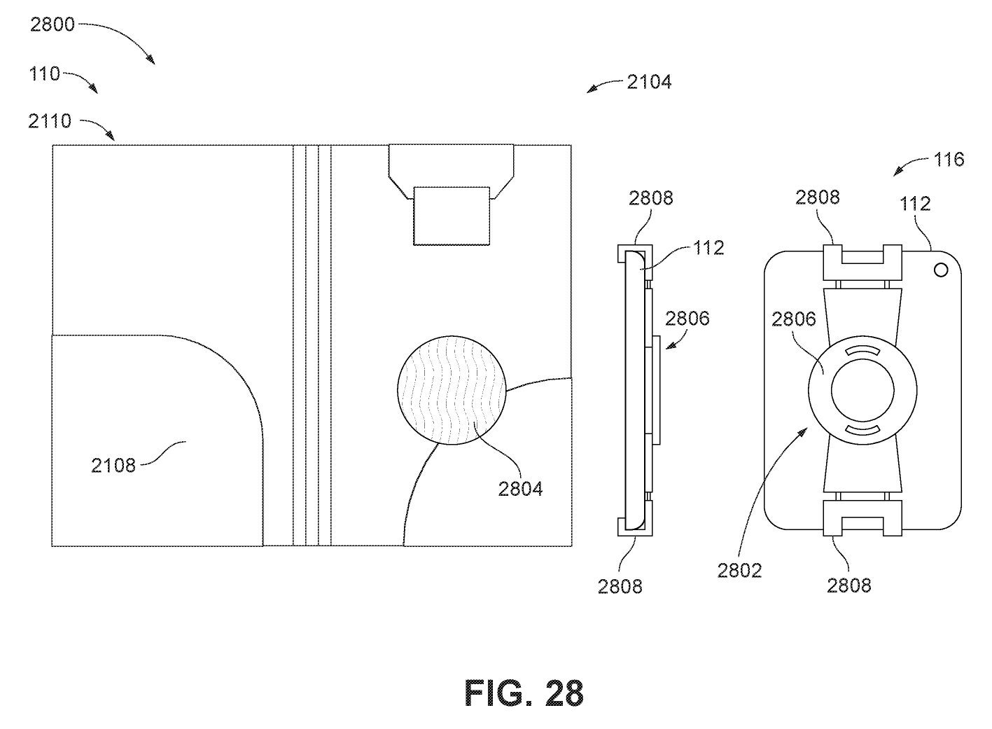

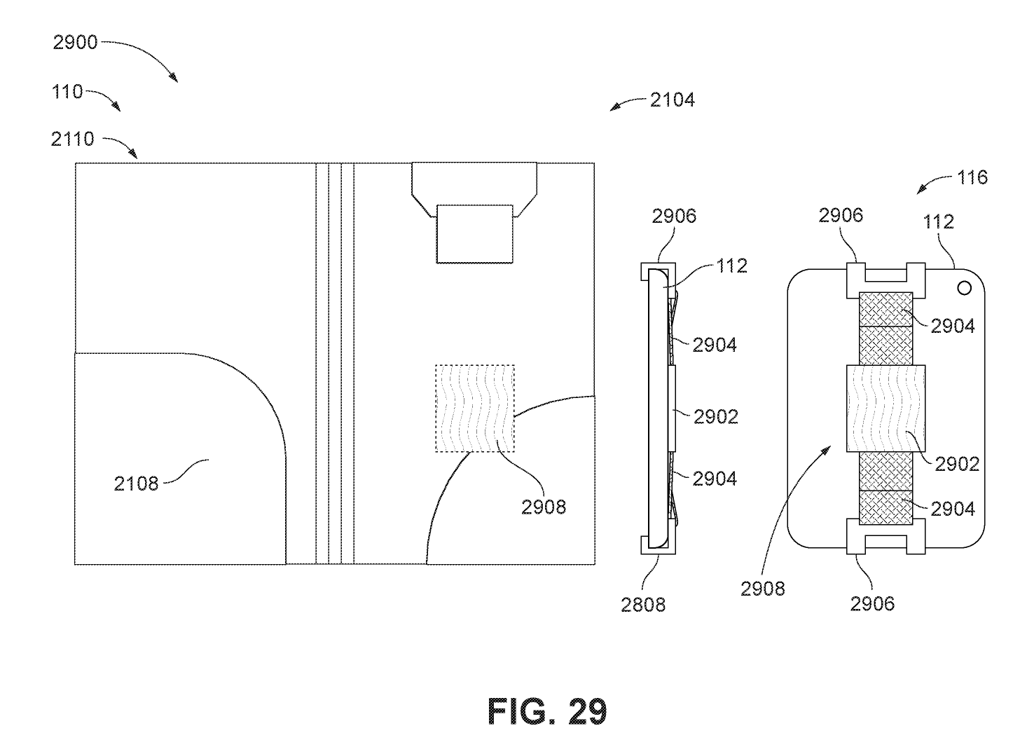

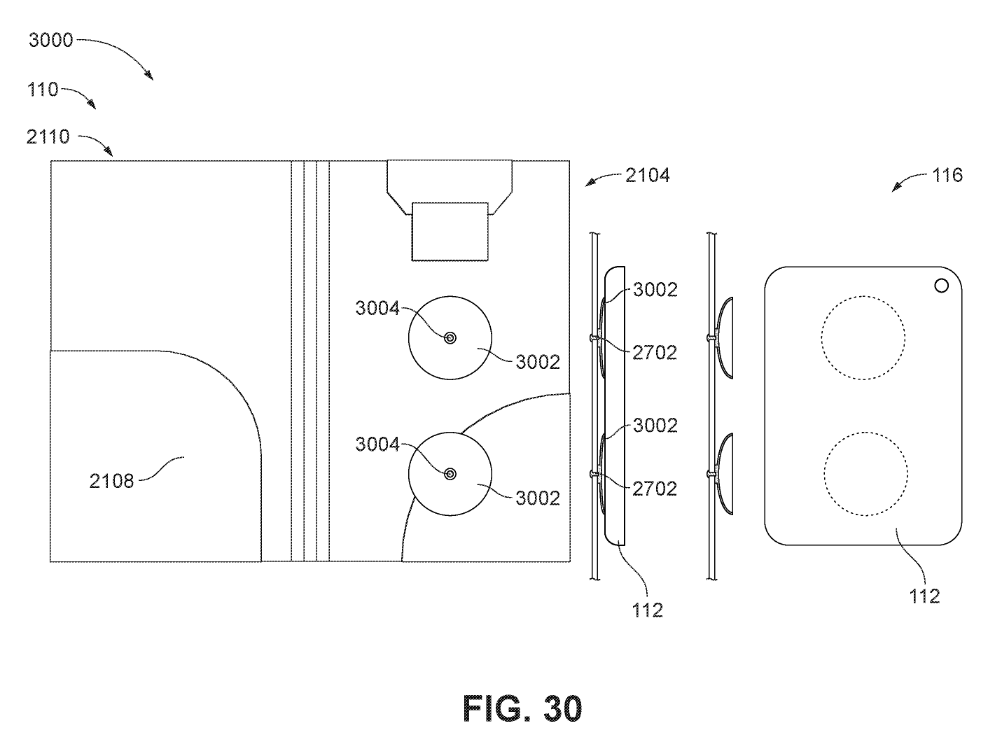

Turning now to FIG. 21, FIG. 22, FIG. 23, FIG. 24, FIG. 25, FIG. 26, FIG. 27, FIG. 28, FIG. 29 and FIG. 30, the communication/survey devices 131, 132, and 133 is referenced in the embodiments below as display device 112. The display device 112 may be integrated with the check presenter folder 110 to be presented to customers. The display device 112 may comprise a touch sensitive display screen interface and may include but is not limited to tablets, smart phones, PDAs, lap top computers, or the like, or combinations thereof. The display device 112 may also be used for but is not limited to feedback, input, marketing info retrieval, credit card payment screen, printing of receipts, coupons, promotions, announcements, schedule of events, specials and the like. The check presenter folder 110 may be configured to hold display device 112 of various sizes. The check presenter folder 110 may also be constructed from various materials to provide varying looks, durability, design, or style as desired by the user. The check presenter folder 110 may hold the display device 112 using one of various embodiments of restraining device 116. In an embodiment, the check presenter folder 110 may be a synthetic leather check presenter folder 110 configured to hold the display device 112. Various embodiments of the check presenter folder 110 may include the check presenter folder being available in a 5″×9″ size or in a 6″×10″ size. Other sizes of check presenters 110 may also be used and modified to hold a display device 112 with a different size. The generic check presenter folder may be prepared for modification in the following manner as shown in FIG. 21 and FIG. 22.

Turning now to FIG. 21, in an embodiment, a generic check presenter 110 is shown in an open position. The generic check presenter 110 may take the form of a folder or booklet and when opened, the check presenter 110 may comprise a first side 2104 and a second side 2110. The check presenter 110 may be modified to further comprise a first bottom corner pocket 2102 on a bottom portion of the first side 2104 and a clip or flap 2106 at the top portion of the first side 2104. The first bottom corner pocket 2101 may be used to hold the check for the customer. The first bottom corner pocket 2101 may be formed in the shape of a quarter-circle with the straight portions of the pocket 2101 aligned with the edges of the first side 2104. When secured on the first side 2104, the rounded portion of the corner pocket 2101 may be positioned towards the center of the presenter 110 while the vertex corner of the pocket 2101 may be aligned with the corner of the first side 2104.

The clip or flap 2106 may be secured along a top portion of the first side 2104. The clip or flap 2106 may be sized to be slightly larger than the size of a standard credit card. The clip or flap 2106 may be configured for holding a credit card. The generic check presenter 110 may also comprise a second bottom corner pocket 2108 on the second side 2110 of the open generic check presenter 110. The second bottom corner pocket 210 may be facing or opposite the first side 2104 of the open generic check presenter 110.

Alternatively, the first side 2104 may be constructed without either of the corner pocket 2102 or the flap 2106. The first side 2104 may also comprise just the clip or flap 2106 alone. The check presenter 110 may further comprise a clean area 2112 for prepping the first side 2104 prior to securing the clip or flap 2106 and/or the corner pocket 2102 on the first side 2104. The clean area 2112 may be on the first side 2104 of the open generic check presenter 110 and may be prepped by wiping the area 2112 clean with methyl-ethyl-ketone (MEK) solvent. The second side 2110 may similarly be prepared as clean area 2112 for the adherence of the second bottom corner pocket 2108.

Turning now to FIG. 22, the generic check presenter 110 is shown with the clip or flap 2106 and the first bottom corner pocket 2102 secured to the first side 2104. The clip or flap 2106 may be secured to the first side 2104 of the open generic check presenter 110 using a first thin bead of adhesive 2114. The adhesive 2114 may be applied on the clean area 2112 to secure the clip or flap 2106. The adhesive 2114 used for securing the clip or flap 2106 may include but is not limited to methyl-methacrylate adhesive (MMA), polyvinyl acetate, aliphatic, cyanoacrylate, epoxy, contest cement, polyurethane glue, and the like. The adhesive 2114 may secure the clip or flap 2106 in a closed position. The first bottom corner pocket 2102 of the open generic check presenter 110 may also be secured to the generic check presenter 110 using a second thin bead of adhesive 2116. The adhesive 2116 may secure the first bottom corner pocket 2102 on the first side 2104 of the open generic check presenter 110. Alternatively, the clip or flap 2106 and the corner pocket 2102 may be secured to the first side 2104 using mechanical fasteners including but not limited to stitching, stapling, sewing, rivets, and the like.

Turning now to FIG. 23, a first check presenter apparatus 2300 supporting the display device 112 may be constructed from a generic check presenter 110 that has been prepared as described above. In an embodiment, the restraining device 116 may be two cooperating pieces of self-adhesive strips 2302 and 2304 of hook-and-loop fastener material. A first piece of the self-adhesive strips of hook-and-loop fastener material 2302 may be of a material such as Velcro®. The first piece of fastener material 2302 may be applied to the first side 2104 of the generic check processor 110, over the clean area 2112, as shown in FIG. 21. Either the hook-type strip or the loop-type strip may be applied to the generic check presenter 110. The second cooperating piece of the self-adhesive strips of hook-and-loop fastener material 2304 may be applied to the rear, or back side, of display device 112. The display device 112 prepared in this manner may then be attached to the generic check presenter 110 with the contacting of the cooperating strips of self-adhesive hook-and-loop fastener material 2302 and 2304 as retaining device 116. The combination of the display device 112 retained in the generic check processor 110 is shown as first check presenter apparatus 2300 in FIG. 23.

Turning now to FIG. 24, another embodiment of the check presenter apparatus 2400 supporting the display device 112 is shown. The check presenter apparatus 2400 may be constructed from a generic check presenter 110 that has been prepared as described above with reference to FIG. 21 and FIG. 22. The restraining device 116 for the check presenter apparatus 2400 may be a shell 2402 that has been specifically designed to hold a particular display device 112 in place. Various different shells 2402 may be used in constructing the check presenter apparatus 2400 depending on the specific display device 112 being retained. In an embodiment, the shell 2402 may be a hard plastic shell including but not limited to acrylonitrile butadiene styrene (ABS) injection molded shell. The shell 2402 may comprise an outer lip 2404 that applies tension to the circumference of the display device 112 to securely retain the display device 112 within the check present apparatus 2400.

The shell 2402 may be attached to the generic check presenter 110 using an adhesive 2406 including but not limited to MMA (methyl methacrylate adhesive). The adhesive 2406 may be applied over the clean area 2112 shown in FIG. 21. The adhesive 2406 may be applied to the first side 2104 of the generic check presenter 110 within a boundary that matches the pattern of outer lip 2404 such that the shell 2402 may be adhered to the adhesive 2406 applied on the first 2104. A display device 112 may then subsequently be placed within the shell 2402, serving as retaining device 116, to form the second check presenter apparatus 2400.

Turning now to FIG. 25, an embodiment of a third check presenter apparatus 2500 supporting the display device 112 is shown. The check presenter apparatus 2400 may be constructed from a generic check presenter 110 that has been prepared as described above with reference to FIG. 21 and FIG. 22. In an embodiment, the restraining device 116 for the check present apparatus 2500 may be a deconstructed “universal” hand-held grip holder for securing any size display device 112. The restraining device 116 may be a Swivel Grip Hand-Held Holder for Tablets (“Swivel Grip”) available from Urge Basics at http://www.urgebasics.com/swivel-grip-hand-held-holder-for-tablets/.

The Swivel Grip device is available with a hand grip and cooperating hand strap for securely grasping the Swivel Grip device. The Swivel Grip device may be partially deconstructed to remove the hand grip and cooperating hand strap. The deconstructed Swivel Grip device may comprise an ABS plastic center portion 2502 and elastomeric molded rubber bands 2504 for retaining the display device 112. The center portion 2502 of the universal holder may be adhered to the first side 2104 of the generic check presenter 110 by placing a bead of adhesive 2506 on the surface of the center portion 2502 contacting the generic check presenter 110. The surface of the center portion 2502 may comprise “anchor points” 2506A, 2506B, and 2506C in which the adhesive may be applied to for securing the Swivel Grip device. The Swivel Grip device may be attached to the clean area 2112 on the first side 2104 of the check presenter 110 shown in FIG. 21. The display device 112 may then be installed within the check presenter apparatus 2500 by being retained by the Swivel Grip device. The display device 112 may be retained by the Swivel Grip device by positioning the display device 112 in the center portion 2502 and stretching the elastomeric bands 2504 of the over two diagonally opposite corners of the display device 112. The third check presenter apparatus 2500 is thereby formed by installing the deconstructed “universal” hand-held gripping apparatus into a generic check presenter 110 as described above.

Turning now to FIG. 26, an embodiment of a fourth check presenter apparatus 2600 supporting the display device 112 is shown. The check presenter apparatus 2600 may be constructed from a generic check presenter 110 that has been prepared as described above with reference to FIG. 21 and FIG. 22. The restraining device 116 for the check presenter 2600 may comprise the combination of a magnet 2602 embedded in the generic check presenter 110, and a self-adhesive piece of magnetically-attractive material 2604 secured on the display device 112. The magnetically-attractive material 2704 used for securing the display device 112 may be any ferromagnetic metal including but is not limited to iron, nickel, cobalt, gadolinium, dysprosium, alloys such as steel, and the like. In the embodiment, the magnet 2602 may be an N50 grade magnet, available from K J Magnetics, Inc. at http://www.kjmagnetics.com, for example. The magnet 2602 may be inserted through a slit 2606 on the first side 2104 of the generic check presenter 110. The check presenter 110 may comprise a dense cardboard inner core that keeps both sides of the check presenter stiff. The magnet 2602 may be adhered to the dense cardboard inner core using an adhesive. The self-adhesive piece of magnetically-attractive material 2604 may then be affixed to the back side of display device 112. The display device 112 may then be affixed to the first side 2104 of the generic check presenter 100 and retained by the magnetism between magnet 2602 and the self-adhesive piece of magnetically-attractive material 2604.

Turning now to FIG. 27, an embodiment of a fifth check presenter apparatus 2700 for the supporting the display device 112 is shown. The check presenter apparatus 2700 may be constructed from a generic check presenter 110 that has been prepared as described above with reference to FIG. 21 and FIG. 22. The restraining device 116 of the check presenter apparatus 2700 may be the combination of two or more magnets 2702 embedded in the generic check presenter 110, and two or more self-adhesive pieces of magnetically-attractive material 2704 secured on the display device 112. The magnetically-attractive material 2704 used for securing the display device 112 may be any ferromagnetic metal including but is not limited to iron, nickel, cobalt, gadolinium, dysprosium, alloys such as steel, and the like. In the embodiment shown in FIG. 27, the two or more self-adhesive pieces of magnetically-attractive material 2704 affixed to the display device 112 may be 0.014″ thick discs of ferromagnetic metal. In the embodiment shown, the metal plates may for example be metal plates by Comport. The material 2704 may be secured to the back side of the display device 112 with an adhesive. The size, shape, thickness, and number of pieces of magnetically-attractive material 2704 may be varied during construction of the check presenter apparatus 2700 as desired. The two or more self-adhesive pieces of magnetically-attractive material 2704 may be affixed to the back side of display device 110 as shown in FIG. 27.

The display device 112 affixed with the magnetically-attractive material 2704 may be retained by a corresponding magnetic mount in the check presenter 2700. The magnetic mount may comprise a MagGrip Vent Magnetic Universal Car Mount by TechMatte® deconstructed and modified to for use with the generic check presenter 110. The back of magnetic the magnetic mount, which was designed to wedge in the AC vents of an automobile, may be removed leaving a metal plate 2706 holding magnets 2702 with a threaded hole 2708 in the center of the metal plate 2706. In an embodiment, a soft rubber cover 2710 may be provided to cover the one or more ferromagnetic metal plates 2706 and associated magnets 2702. Two holes 2712 may be drilled through the back of the generic check presenter 110 for receiving two mechanical fasteners such as mounting screws 2714, for example. Alternatively, other mechanical fasteners may be used including but not limited to bolts, clasps, clips, latches, pins, snap fastener, twist tie, buckles, and the like. The two mechanical fasteners 2714 may be placed through the drilled holes 2712 and affixed to the back of each of the metal plates 2706 holding the magnets 2702. The display device 112 thus prepared may be affixed to the first side 2104 of the generic check presenter 100 and retained by magnetism between magnets 2702 and self-adhesive pieces of ferromagnetic metal 2704 to form the fifth check presenter apparatus 2700.

Turning now to FIG. 28, an embodiment of a sixth check presenter apparatus 2800 for supporting the display device 112 is shown. The check presenter apparatus 2800 may be constructed from a generic check presenter 110 that has been prepared as described above with reference to FIG. 21 and FIG. 22. The restraining device 116 for the check presenter 2800 may comprise a spring-tension holding device such as the Twist 360 II Spring Tension Universal Holding Device by Bracketron. The universal holding device may be deconstructed leaving just the spring tension portion shown as holding device 2802. To attach the holding device 2802 to the generic check presenter 110, an adhesive 2804 may be placed on the generic check presenter 110 or on the holding device 2802, to adhere the holding device 2802 to the generic check presenter 110. In an embodiment, the surface of the holding device 2802 in contact with the generic check presenter may comprise a bottom surface of a central spring tensioner 2806. The spring tensioner 2806 may configure the holding device 2802 with a spring tension force between two opposite clamps 2808. The holding device 2802 may be positioned in the center of the first side 2104 of the generic check presenter 110. The holding device 2802 may be affixed to the clean area 2112 shown in FIG. 21. To attach a display device 112 to the holding device 2802, force may be applied to the two clamping ends 2808 of the holding device 2802 to spread the clamping ends 2808 apart for receiving the display device 112. Upon positioning the display device 112 between the clamping ends 2808, the opposite clamping ends 2808 may be released to spring back towards their original positioning which in turn may apply a tension force on the display device 112. The holding device 2802 may therefore clamp the display device 112 in place to retain the display device 112 in the check presenter apparatus 2800.

Turning now to FIG. 29, an embodiment of a seventh check presenter apparatus 2900 is shown for supporting the display device 112. The check presenter apparatus 2900 may be constructed from a generic check presenter 110 that has been prepared as described above with reference to FIG. 21 and FIG. 22. The restraining device 116 for the check presenter 2900 may comprise a security strap with elastic band tension and holding hooks. In an embodiment, a Security Hand Strap with 360° Rotation Metal Ring Finger-Grip Holder & Stand with Nylon Elastic Band Tension Universal Holding Device by TFY may be deconstructed to only include a center plate 2902 centered on an nylon elastic band 2904, the elastic band 2904, and two hooks 2906 on either end of the elastic band 2904. An adhesive may then be placed on the back of the center plate 2902 to affix the center plate 2902 on the first side 2104 of the generic check presenter 110. The center plate 2902 may be permanently adhered to the generic check presenter 110 over the clean area 2112 shown in FIG. 23. The display device 112 may be held in place by stretching both hooks 2906 over the top and bottom side of the display device 112. The display device 112 may be held in place in the seventh check presenter apparatus 2900 using the tension of the elastic band 2904 and the two hooks 2906 on either end of the elastic band 2904.

Turing now to FIG. 30, in an embodiment, an eighth check presenter apparatus 3000 for supporting the display device 112 is shown. The check presenter apparatus 3000 may be constructed from a generic check presenter 110 that has been prepared as described above with reference to FIG. 21 and FIG. 22. The restraining device 116 for the check presenter 3000 may be one or more suction cups mounted to the generic check presenter 110. In an embodiment, 2-1.73″ suction cups 3002 may be attached to the first side 2104 of the generic check presenter 110 for retaining the display device 112. Alternatively, the number and size of suction cups may be used depending on the size and weight of the display device 112 being retained. The suction cups 3002 may be secured to the check presenter 110 using mechanical fasteners such as threaded studs 3004 anchored through the back of the suction cups 3002. Alternatively, other mechanical fasteners may be used including but not limited to bolts, clasps, clips, latches, pins, snap fastener, twist tie, buckles, and the like.

In the embodiment shown, suction cups from DANXQ were used. The suction cups 3002 may be evenly positioned on the first side 2104 of the generic check presenter 110 such that there may be a balanced adherence applied to the top and bottom portion of the display device 112 being retained. The display device 112 may be retained by being positioned over the suction cups 3002 on the first side 2104 of the generic check presenter 110 and pressed down to secure the display device 112 to the generic check presenter 3000. The suction cups 3002 may retain the display device 112 using suction directed upon areas 3006 on the back side of the display device 112 corresponding to the position of the suction cups 3002 upon the back side of the display device 112.

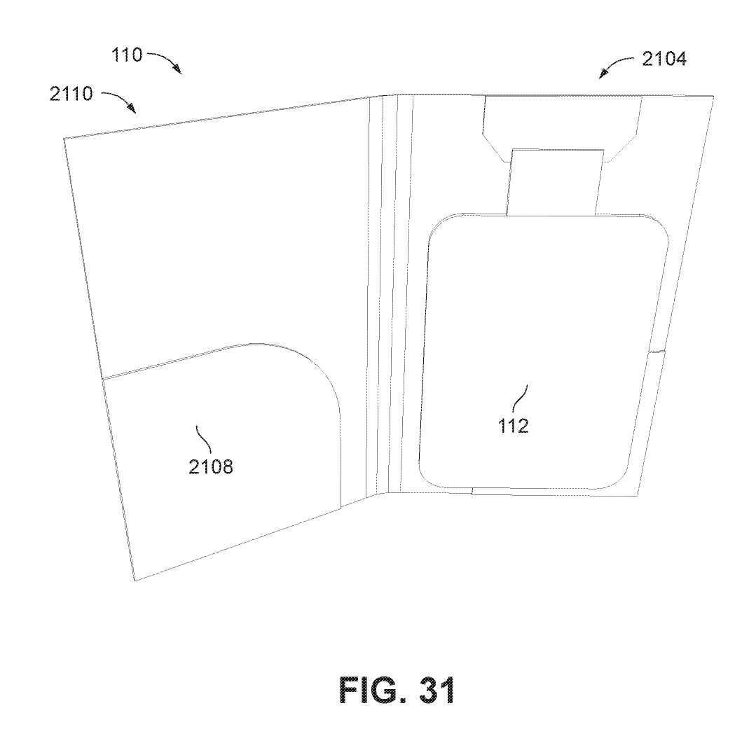

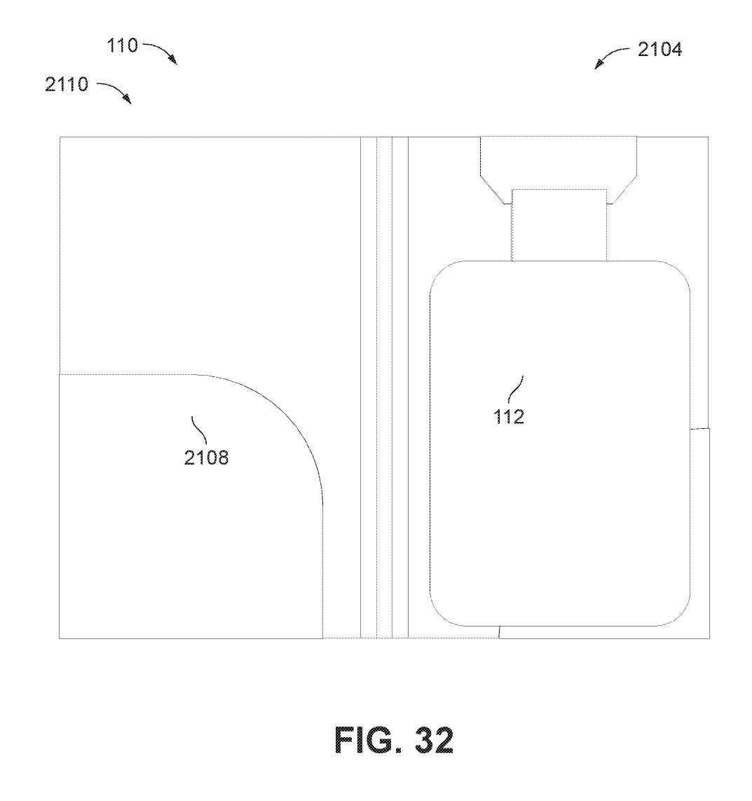

FIG. 31 and FIG. 32 show an embodiment of the display device 112 affixed to the check presenter 110. After the display device 112 is secured to the check presenter 110, the combined check presenter and digital device assembly may be presented together to customers such that customers may be presented with the survey system 100 to give their feedback while paying the check. This ensures that the feedback from the customer is provided real-time immediately after their dining experience.

Having thus described the present invention by reference to certain of its exemplary embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Additional details are presented the Appendix attached hereto and incorporated by reference for all purposes. Many such variations and modifications may be considered desirable, based upon a review of the foregoing description of exemplary embodiments. Accordingly, it is appropriate that any claims supported by this description be construed broadly and in a manner consistent with the scope of the invention.

1. A survey system for collecting customer service ratings, comprising:
a survey server connected to at least one assess point, the access point configured to establish a wireless communication connection to one or more communication devices meeting a geo-fence location restriction;
the one or more communication devices configured to execute computer code and function as a survey device to display a series of survey screens, each of said survey screens displaying an interactive screen for providing at least one survey rating input;
the survey system operating to require completion of the series of survey screens on the one or more survey devices within a predetermined time within the geo-fence location restriction;
wherein the one or more survey devices provide real-time survey inputs to the survey system for immediate analysis.

2. The survey system of claim 1, further comprising:
an instantaneous alert in real-time for received survey results not meeting a minimum threshold rating.

3. The survey system of claim 1, further comprising:
a completed survey submitted screen displayed on the survey device upon successful submission of a completed survey to the survey system.

4. The survey system of claim 1, wherein the access point comprises multiple access points using a Bluetooth communication protocol with a limited communication range arranged to implement a geo-fence.

5. The survey system of claim 1, wherein the access point comprises at least one access point using a Wi-Fi communication protocol and implementing a geo-fence utilizing at least in part one of an indoor positioning system or a global positioning system.

6. The survey system of claim 1, wherein the geo-fence relies on location data provided by internal hardware of the communication device.

7. The survey system of claim 1, further comprising:
storing a plurality of survey results on a memory associated with the survey server; and
displaying at least a portion of the survey results on a searchable Internet website.

8. The survey system of claim 1, wherein the one or more communication devices is mounted in a folder apparatus for functioning as the survey device when the folder apparatus is presented.

9. A method for collecting customer service ratings, comprising the steps of:
configuring a survey server having associated access points with computer code and connecting said server to at least one assess point, the access point operated by the computer code to establish a wireless communication connection to one or more communication devices meeting a geo-fence location restriction;
executing computer code on the one or more communication devices to function as a survey device;
displaying a series of interactive survey screens on the one or more survey devices, each of said interactive survey screens providing for at least one survey rating input;
requiring completion of the series of interactive survey screens on the one or more survey devices within a predetermined time within the geo-fence location restriction; and
providing real-time survey inputs from one or more survey devices for immediate analysis.

10. The method of claim 9, further comprising the step of:
providing an instantaneous alert in real-time for one or more survey ratings not meeting a minimum threshold rating.

11. The method of claim 9, further comprising the step of:
generating a completed survey submitted screen for display on the survey device upon successful submission of a completed survey.

12. The method of claim 9, wherein the access point comprises multiple access points with at least one access point using a limited range communication protocol implementing a geo-fence.

13. The method of claim 9, wherein the access point comprises multiple access points with at least one access point using a Wi-Fi communication protocol and implementing a geo-fence utilizing at least in part one of an indoor positioning system or a global positioning system.

4. The method of claim 9, further comprising the steps of:
receiving location data provided by internal hardware of the survey device; and
implementing the geo-fence restriction based at least in part based on the location data received from the survey device.

15. The method of claim 9, further comprising the step of:
storing a plurality of survey results on a memory associated with the survey server.

16. The method of claim 15, further comprising the steps of:
providing a customer Internet website hosting a searchable database of the plurality of survey results; and
displaying at least a portion of the survey results on a searchable Internet website.

17. A method for operating a survey system having at least one survey server, comprising the steps of:
providing a survey system having a display device and at least one access point implementing a geo-fenced-restricted communication protocol;
establishing a wireless communication link using the communication protocol and configuring a survey device to communicate a survey rating within implemented geo-fence parameters;
setting a predetermined time limit for completing a survey comprised of at least one survey rating on the survey device;
displaying an interactive survey rating screen on the survey device to use to enter a rating for a provided service; and
receiving from the survey device a survey rating for compiling and displaying in real-time on the survey system display device.

18. The method of claim 17, further comprising the step of:
providing an acknowledgement of a completed survey receipt on the survey system to the survey device.

19. The method of claim 17, further comprising the steps of:
providing survey results to a manager; and
generating an instantaneous alert to the manager if a submitted survey result fails to comply with a threshold minimum rating.

20. The method of claim 17, wherein the access point comprises multiple access points with at least one access point using a wireless communication protocol and implementing a geo-fence utilizing at least in part one of the following:
1) an indoor positioning system; or
2) a global positioning system.

21. The method of claim 17, further comprising the steps of:
receiving location data provided by internal hardware of the survey device; and
implementing the geo-fence restriction based at least in part based on the location data received from the survey device.
